(19) United States
(12) Patent Application Publication
(10) Pub. No.: US 2024/0400411 A1
(43) Pub. Date: Dec. 5, 2024

(54) Method for the Manufacture of Cathode Materials

(71) Applicant: Sylvatex, Inc., ALAMEDA, CA (US)

(72) Inventors: Melvin Louis Luetkens, JR., Batavia, IL (US); Edward Stafford, Mountain View, CA (US); Matthew Crafton, Berkeley, CA (US); YanYing Liu, Fremont, CA (US)

(73) Assignee: Sylvatex, Inc., ALAMEDA, CA (US)

(21) Appl. No.: 18/680,725

(22) Filed: May 31, 2024

Related U.S. Application Data
(60) Provisional application No. 63/505,375, filed on May 31, 2023.

(51) Int. Cl. C01G 53/00; H01M 4/525

(52) U.S. Cl. CPC C01G 53/50; H01M 4/525; C01P 2002/52; C01P 2002/72; C01P 2004/03; C01P 2004/61; C01P 2004/84; C01P 2006/40

(57) ABSTRACT

A method of producing a particulate lithium mixed metal oxide cathode material comprising the steps of providing an organic compound, having a melting point above 50° C., providing a lithium compound, providing two or more metal compounds, mixing the organic compound, the lithium compound, and the two or more metal compounds to form a mixture, calcining the mixture at a calcining temperature, in an atmosphere containing oxygen to combust the organic compound and to form a lithium mixed metal oxide, cooling the lithium mixed metal oxide to below 60° C., and sizing the cooled lithium mixed metal oxide to produce particulate lithium mixed metal oxide having a predetermined average particle size.

### CROSS-REFERENCE TO RELATED APPLICATIONS

This application claims priority to U.S. Provisional Patent Application No. 63/505,375 titled “Method for the Manufacture of Cathode Materials” filed on May 31, 2023.

### TECHNICAL FIELD

The present disclosure relates to lithium-ion battery cathode materials.

### BACKGROUND

Lithium-ion batteries (LIBs) have emerged as the leading technology to power electric vehicles (EVs). However, the biggest issue with making this transition today is that the demand for lithium-ion batteries far outstrips our ability to supply the market. To hit critical market adoption, the LIB must be safe, low-cost, and feature high-energy-density. Furthermore, the overall impact of battery manufacturing itself needs to have a much lower carbon footprint. It is thus critical to develop low-cost, sustainable manufacturing practices.

According to the findings by the LIFE Institute for Climate, Energy, and Society, the processes to produce the cathode make up about 45% of the greenhouse gas emissions of the total material production of LIBs. Furthermore, 80% of an EV's total lifetime emissions come from the embodied energy of fabricating the battery and then charging the battery. Conventional wet processing methods for cathode production typically create large amounts of solvents that need to be disposed of or recycled using energy-intensive collection and distillation systems. For this reason, the cathode production methods have much potential to lower the carbon footprint of EVs.

### SUMMARY

One aspect of the present invention is a method of producing a particulate lithium mixed metal oxide cathode material comprising the steps of providing an organic compound, having a melting point above 50° C., providing a lithium compound, providing two or more metal compounds, mixing the organic compound, the lithium compound, and the two or more metal compounds to form a mixture, calcining the mixture at a calcining temperature, in an atmosphere containing oxygen to combust the organic compound and to form a lithium mixed metal oxide, cooling the lithium mixed metal oxide to below 60° C., and sizing the cooled lithium mixed metal oxide to produce particulate lithium mixed metal oxide having a predetermined average particle size.

In another aspect of the invention, the mixture is milled before calcining.

In a still further aspect, the calcining step is achieved by a gradual addition of heat, so as to first melt the organic compound and then calcine the mixture, including the organic compound.

In a yet still further aspect, the method further comprising an intermediate calcining step after forming the mixture where the temperature is held for a period of time above the melting temperature but below the boiling point of the organic compound before calcining at higher temperatures to combust the organic compound.

In another aspect, the method further comprising an annealing step between the calcining step and the cooling step, in which annealing step the mixed metal oxide is held at an annealing temperature for at least 0.25 hours up to 10 hours and at a temperature in the range of 600-800° C.

In another aspect of the invention, the method further comprising an intermediate calcining step in an oxygen atmosphere after cooling the formed lithium mixed metal oxide.

In still another aspect, the method further comprising an intermediate milling step after the intermediate calcining step. A sizing step may be added after the intermediate milling step.

In a still yet further aspect, wherein the cooled lithium mixed metal oxide is milled before sizing the cooled lithium mixed metal oxide.

In another still yet further aspect, wherein the organic compound is selected from the group consisting of citric acid, oxalic acid, ascorbic acid, glucose, glycine, dimethyl oxalate, phenanthrene, oxamide, maleic acid, tartaric acid, suberic acid, stearic acid, sucrose, linoleic acid and maltose.

In another aspect of the invention, the organic compound is a polymer, an oligomer, or an aromatic compound or a non-aromatic compound and may comprise one or more functional groups selected from the group consisting of an amino, carboxylic acid, ether, amide, carbonate, acetate, and hydroxyl group.

In still another aspect, the organic compound is a monoacid, diacid, or triacid.

In a still further aspect, the mixed metal oxide comprises a composition of LiNi_{0.8}Mn_{0.1}CO_{0.1}O₂.

In a yet still further aspect, the two or more metal compounds comprises metals selected from the group consisting of manganese, nickel, aluminum, or cobalt.

In another aspect, when the organic compound has a high heat of decomposition and low decomposition temperature or low heat of decomposition and high decomposition temperature results in larger particle sizes of the lithium mixed metal oxides than when the organic compounds have higher heat of decomposition and higher decomposition temperature or lower heat of decomposition and lower decomposition temperature.

In another aspect of the invention, the lithium compound or the two or more metal compounds comprises an anionic component that is selected from the group consisting of hydroxide, carbonate, acetate, alkoxide, oxalate, nitrate, nitride, sulfate, and oxide.

In still another aspect, the lithium mixed metal oxide cathode further comprises an outer layer. The outer layer may comprise Li and Co-rich material. The forming the outer layer of Li and Co-rich material on the comminuted mixed metal oxide cathode may comprise the following steps of tumbling the lithium mixed metal oxide with Li and Co-containing precursor materials to form a coated lithium mixed metal oxide, and calcining the coated lithium mixed metal oxide to form a lithium mixed metal oxide with a Li and Co-rich layer such that the Co does not substantially enter the structure of the lithium mixed metal oxide portion.

In a still further aspect, the calcining step comprises the following steps of placing the mixture in a calciner, heating the mixture to about 125-175° C. at a ramp rate of up to about 30° C./min and holding for about 0.5 to ten hours, heating the mixture to about 200-300° C. at a ramp rate of up to about 15° C./min and holding for about 0.5 to ten hours, heating the mixture to about 300-400° C. at a ramp rate of up to about 10° C./min and holding for about 0.5 to ten hours, heating the mixture to about 500-600° C. at a ramp rate of up to about 10° C./min and holding for about 0.5 to about ten hours, heating the mixture to about 700-800° C. at a ramp rate of up to about 10° C./min and holding for about 0.5 to about ten hours, heating the mixture to about 900-1000° C. at a ramp rate of up to about 10° C./min and holding for about 0.5 to about ten hours, cooling the mixture to about 700-800° C. at a ramp rate of up to about 10° C./min and holding for about 0.5 to about ten hours, and cooling to room temperature.

In a still yet further aspect, calcining the mixture comprises the following steps of heating to about 900-1000° C. at a ramp rate of up to about 0.25 to about 30° C./min and holding for about 0.5 to 10 hours, and cooling the mixture to about 700-800° C. at a rate of up to about 0.25 to about 30° C./min and holding for about 0.5 to 10 hours.

In another still yet further aspect, the method further comprising adding a dopant to the mixture.

In another aspect of the invention, the lithium mixed metal oxide cathode comprises a coating of an electrically conductive carbon.

In still another aspect, the particles are substantially single crystalline or polycrystalline and have a particle size in the range of about 1-100 microns.

In a still further aspect, the organic compound is provided in an amount between about 0.01 and 50 mole percent of the metal compounds.

Further aspects and embodiments are provided in the foregoing drawings, detailed description, and claims. Unless specified otherwise, the features as described herein are combinable and all such combinations are within the scope of this disclosure.

### BRIEF DESCRIPTION OF THE DRAWINGS

The following drawings are provided to illustrate certain embodiments described herein. The drawings are merely illustrative and are not intended to limit the scope of claimed inventions and are not intended to show every potential feature or embodiment of the claimed inventions. The drawings are not necessarily drawn to scale; in some instances, certain elements of the drawing may be enlarged with respect to other elements of the drawing for purposes of illustration.

FIG. 1 is a block diagram of a melt-based, one-pot method to manufacture a particulate lithium metal oxide, according to an embodiment of the disclosure.

FIG. 2 is a block diagram of a melt-based, one-pot method to manufacture a particulate lithium mixed metal oxide, according to an embodiment of the disclosure.

FIG. 3A is an SEM of particles of LiNi_{0.8}Mn_{0.1}Co_{0.1}O₂ 300 synthesized using method 200 and citric acid as the organic compound.

FIG. 3B is the XRD pattern of LiNi_{0.8}Mn_{0.1}Co_{0.1}O₂ 300 synthesized using method 200 and citric acid as the organic compound.

FIG. 4A is an SEM of particles of LiNi_{0.8}Mn_{0.1}Co_{0.1}O₂ 302 synthesized using method 200 and oxalic acid as the organic compound.

FIG. 4B is the XRD pattern of LiNi_{0.8}Mn_{0.1}Co_{0.1}O₂ 302 synthesized using method 200 and oxalic acid as the organic compound.

FIG. 5A is an SEM of particles of LiNi_{0.8}Mn_{0.1}Co_{0.1}O₂ 304 synthesized using method 200 and ascorbic acid as the organic compound.

FIG. 5B is the XRD pattern of LiNi_{0.8}Mn_{0.1}Co_{0.1}O₂ 304 synthesized using method 200 and ascorbic acid as the organic compound.

FIG. 6A is an SEM of particles of LiNi_{0.8}Mn_{0.1}Co_{0.1}O₂ 306 synthesized using method 200 and glucose as the organic compound.

FIG. 6B is the XRD pattern of LiNi_{0.8}Mn_{0.1}Co_{0.1}O₂ 306 synthesized using method 200 and glucose as the organic compound.

FIG. 7A is an SEM of particles of LiNi_{0.8}Mn_{0.1}Co_{0.1}O₂ 308 synthesized using method 200 and glycine as the organic compound.

FIG. 7B is the XRD pattern of LiNi_{0.8}Mn_{0.1}Co_{0.1}O₂ 308 synthesized using method 200 and glycine as the organic compound.

FIG. 8A is an SEM of particles of LiNi_{0.8}Mn_{0.1}Co_{0.1}O₂ 310 synthesized using method 200 and dimethyl oxalate as the organic compound.

FIG. 8B is the XRD pattern of LiNi_{0.8}Mn_{0.1}Co_{0.1}O₂ 310 synthesized using method 200 and dimethyl oxalate as the organic compound.

FIG. 9 is a plot of the effect of enthalpy of combustion of the organic compound on average primary particle diameter.

FIG. 10 is a plot of the effect of enthalpy of combustion of the organic compound on the first discharge capacity.

FIG. 11 is a graph of the effect of flux stability of the organic compound used on the electrochemical performance.

FIG. 12 is a graph of the effect of flux stability of the organic compound used on the contaminant formation and cation exchange.

FIG. 13 is a block diagram of a melt-based method to manufacture a particulate lithium metal phosphate, according to an embodiment of the disclosure.

FIG. 14 is a block diagram of an alternative method 500 to manufacture a particulate lithium mixed metal oxide, according to an embodiment of the disclosure.

FIG. 15 is a plot of the response surface of samples 10-26.

FIG. 16 is the response surface profile for cation exchange as a function of heat of combustion and decomposition temperature.

FIG. 17 is an illustrative response surface profile for 1st discharge capacity as a function of organic concentration and heat of combustion.

FIG. 18 is a plot showing the median primary particle size of samples 554-566 as a function of the heat of combustion of the organic additives.

FIG. 19 is a plot showing the median primary particle size of samples 554-566 as a function of decomposition temperature of the organic additives.

FIG. 20 is the particle size analysis of sample 566 with no organic additive.

FIG. 21 is the particle size analysis of sample 560 using sucrose as the organic additive.

FIG. 22 is the capacity retention of samples 554-566 (compared to their first cycle discharge capacity) through the C/10 D/3 cycling step.

FIG. 23 is a plot of capacity retention as a function of D90 particle size.

FIG. 24 is the powder XRD Pattern for NMC811 600 synthesized on large scale with oxamide.

FIG. 25 is the powder XRD Pattern for NMC811 602 synthesized on large scale without an organic additive.

FIG. 26 is the close up of XRD pattern for NMC811 600 synthesized with oxamide between 64-65 degrees two-theta.

FIG. 27 is the close up of XRD pattern for NMC811 602 synthesized without organic additive between 64-65 degrees two-theta.

FIG. 28 is SEM images of NMC811 600 synthesized on large scale with oxamide.

FIG. 29 is SEM images of NMC811 602 synthesized on large scale without and organic additive.

FIG. 30 is the particle size distribution of NMC811 synthesized with an organic additive 600 (top) and without an organic additive 602 (bottom) after milling.

FIG. 31 is the charge capacity as a function of cycle number for samples 600, 602 synthesized at large scale.

FIG. 32 is the discharge capacity as a function of cycle number for samples 600, 602 synthesized at large scale.

### DETAILED DESCRIPTION

### Overview

Embodiments of methods and compositions described herein are directed towards a melt-based method for the manufacture of cathode materials for LIBs. The method includes combining transition metal and lithium-based compounds with an organic compound having a melting point above 50° C. The mixture is calcined in an atmosphere containing oxygen to combust the organic compound and to form a lithium metal oxide. Preferably, the mixture is milled before being calcined.

The calcined material is cooled and sized, e.g. by milling and/or griding, to yield a particulate, preferably single crystalline, lithium mixed metal oxide. In some embodiments, the calcined material is partially cooled to an intermediate temperature and held for a pre-determined period of time before the calcined material is cooled to below about 60° C., preferably room temperature.

In general, the resulting particle size of the lithium mixed metal oxide increases as the embodied energy and/or decomposition temperature of the organic compound increases.

### Definitions

The following description recites various aspects and embodiments of the inventions disclosed herein. No particular embodiment is intended to define the scope of the invention. Rather, the embodiments provide non-limiting examples of various compositions, and methods that are included within the scope of the claimed inventions. The description is to be read from the perspective of one of ordinary skill in the art. Therefore, information that is well known to the ordinarily skilled artisan is not necessarily included.

The following terms and phrases have the meanings indicated below, unless otherwise provided herein. This disclosure may employ other terms and phrases not expressly defined herein. Such other terms and phrases shall have the meanings that they would possess within the context of this disclosure to those of ordinary skill in the art. In some instances, a term or phrase may be defined in the singular or plural. In such instances, it is understood that any term in the singular may include its plural counterpart and vice versa, unless expressly indicated to the contrary.

As used herein, the singular forms “a,” “an,” and “the” include plural referents unless the context clearly dictates otherwise. For example, reference to “a substituent” encompasses a single substituent as well as two or more substituents, and the like.

As used herein, “for example,” “for instance,” “such as,” or “including” are meant to introduce examples that further clarify more general subject matter. Unless otherwise expressly indicated, such examples are provided only as an aid for understanding embodiments illustrated in the present disclosure and are not meant to be limiting in any fashion. Nor do these phrases indicate any kind of preference for the disclosed embodiment.

As used herein, the term “lithium-ion battery,” sometimes abbreviated as “LIB,” is meant to refer to a type of rechargeable battery in which lithium ions move from the negative electrode through an electrolyte to the positive electrode during discharge, and back when charging. Li-ion batteries use an intercalated lithium compound as the material at the positive electrode and typically graphite at the negative electrode.

As used herein, the term “cathode” or “cathode material” is meant to refer to the particulate material that is used to form the cathode electrode that is, in turn, used to assemble a Li ion battery or other polarized electrical device. The cathode material is typically added to a solvent, conductive additive, adhesive, or other materials that are then mixed and coated onto a current collector to form the cathode electrode. The cathode electrode is that from which a conventional current leaves in a polarized electrical device, such as a LIB. A conventional current describes the direction in which positive charges move. Electrons have a negative electrical charge, so the movement of electrons is opposite to that of the conventional current flow.

As used herein, the term “comminution” is meant to refer to the reduction of solid materials from one average particle size to a smaller average particle size, by crushing, grinding, cutting, vibrating, milling or other processes. Impact, shear, and compression forces are typically used to effect the comminution of particles. A media, such as steel or ceramic beads, may be used to effect the comminution.

As used herein, the term “dopant” or “doping agent” is meant to refer to a trace or small amount of impurity element that is introduced into a chemical material to alter its original electrical or optical properties. The amount of dopant necessary to cause changes is typically very low. The amount of dopant may be in the range of about 0.001-5% or about 0.001-1% by mass. When doped into crystalline substances, the dopant's atoms get incorporated into its crystal lattice.

As used herein, the term “spinel” is meant to refer to a class of materials with a spinel crystal structure with the general formula AB₂X₄ which crystallize in the cubic (isometric) crystal system, with the X anions (typically chalcogens, like oxygen and sulfur) being arranged in a cubic close-packed lattice and the cations A and B occupying some or all of the octahedral and tetrahedral sites in the lattice.

As used herein, the term “layered structure” is meant to refer to a class of materials with the general formula AxBO₂ where A is an alkali cation, B is a metal cation, and O is an oxygen anion. The O anions form a face-centered cubic (FCC) framework with octahedral and tetrahedral sites. These two environments are face sharing and form a topologically connected network.

As used herein, the terms “particle sizing” and “particle separation methods” is meant to refer to methods to separate and classify particles based on differences in size, shape, physical or chemical properties of the particles. Solid particles, such as cathode materials described herein, are typically separated by their dimensions (size) using such methods as wet or dry sieving or screening, classifiers, or cyclones.

As used herein, the term “solid-electrolyte interphase (SEI)” is meant to refer to a thin layer that is formed on the surface of the anode from the electrochemical reduction of the electrolyte and plays a crucial role in the long term cyclability of a lithium-based battery. The SEI is typically about 100-120 nm thick, and is mainly composed of various inorganic components, such as lithium carbonate (Li₂CO₃), lithium fluoride (LiF), lithium oxide (Li₂O), lithium hydroxide (LiOH), as well as some organic components such as lithium alkyl carbonates.

As used herein, the term “calcine” means to expose to strong heat. This may occur in a conventional gas fired or electrical furnace or through other means such as flame pyrolysis, plasma pyrolysis, or a dynamic recrystallization process, such as Geometric Dynamic Recrystallization (GDRX).

### Exemplary Embodiments

The present disclosure relates to methods of manufacturing particulate metal oxide and mixed metal oxides. In one method, an organic compound is combined with a lithium-based compound and one or more transition metal-based compounds in desired stoichiometries to form a mixture. The organic compound is added in a 0.01-50% mol concentration to the metal compounds. The mixture is calcined then cooled to below about 60° C., preferably between about 0-60° C., most preferably room temperature, or partially cooled to an intermediate temperature of about 600-800° C. and held for a pre-determined period of time in the range of about 0.25-10 hours, followed by cooling to below about 60° C., preferably between about 0-60° C., most preferably room temperature. The calcined lithium metal oxide or lithium mixed metal oxide is then ground to yield a particulate lithium metal oxide or lithium mixed metal oxide. In another method, the mixture is ground in a mill to form a ground mixture that is calcined to an intermediate temperature then cooled. The cooled material is then ground and calcined to a high temperature then cooled to below about 60° C. to form a lithium metal oxide or lithium mixed metal oxide. The calcined lithium metal oxide or lithium mixed metal oxide is then ground to yield a particulate lithium metal oxide or lithium mixed metal oxide.

In various exemplary embodiments, the metal oxides comprise the general formula LiMₓO_{y} where M is a transition metal, including nickel (Ni), manganese (Mn), cobalt (Co), iron (Fe), aluminum (Al), titanium (Ti), etc., and where x=1, y=2 or where x=2 and y=4.

In other various exemplary embodiments, the lithium mixed metal oxides comprise two or different metals with general formula Li(M1)ₓ(M2)_{y}O₂ where M1 and M2 are different metals and where M1 and M2 are Ni, Mn, Co, or Al, and further where x+y=1.

Lithium mixed metal oxides may comprise three different metals with general formula Li(M1)ₓ(M2)_{y}(M3)₂O₂ where M1 is Ni, M2 is Mn, and M3 is Co, or where M1 is Ni, M2 is Co and M3 is aluminum (Al), and where x+y+z=1.

Lithium mixed metal oxides may comprise three different metals with general formula Li(M1)ₓ(M2)_{y}(M3)_{z}(M4)_{x′}O₂ where M1 is Ni, M2 is Mn, and M3 is Co, and M4 is aluminum (Al), and where x+y+z+x′=1.

In other various embodiments, dopants, or excess lithium (Li) may additionally be added to the mixtures. The dopants preferably replace a portion of the metal component in the particulate cathode materials.

In other various exemplary embodiments, the particulate cathode materials may further comprise a coating. The coating is used to stabilize or improve the cycling and electrical conductivity properties of the particles.

In various embodiments, particulate cathode materials can be made with used and recycled cathode materials using the synthetic methods disclosed.

In other various embodiments, the size of single crystalline cathode particles synthesized by the disclosed methods can be increased by using organic compounds with higher embodied energy and/or decomposition temperature.

### Lithium Metal Oxides

Although currently not preferred, the methods disclosed herein can be used to make a lithium metal oxide. The following embodiments relate to methods to manufacture a metal oxide, in particular a lithium metal oxide.

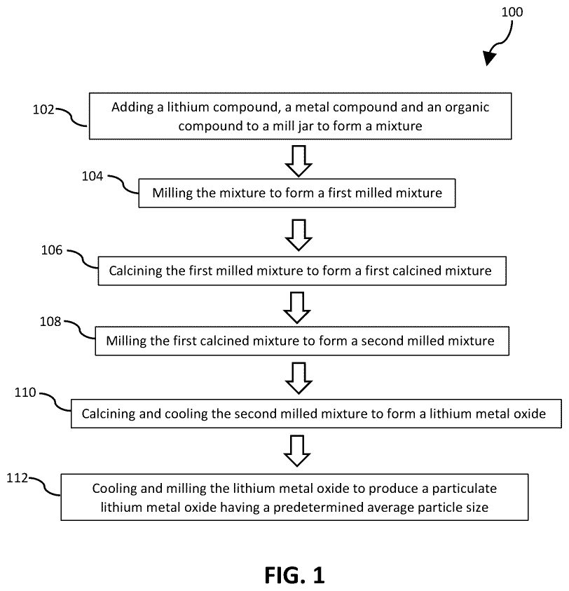

FIG. 1 is a block diagram of a melt-based, “one-pot” method 100 to manufacture a particulate lithium metal oxide, according to an embodiment of the disclosure. In a first step 102, a lithium compound, a metal compound and an organic compound are added to a mill jar. Two or more organic compounds may also be used in the synthesis of the lithium metal oxide and may be added in a 0.01-50% mol concentration of the metal compounds.

The organic compound may be any organic compound with a melting point in the range of about 50-350° C. The organic compound may be any organic compound with a melting point in the range of about 100-300° C. The organic compound may be any organic compound with a melting point in the range of about 150-200° C. The organic compound may be an aromatic compound or a non-aromatic compound and may comprise one or more functional groups selected from the group consisting of an amino, carboxylic acid, ether, amide, carbonate, acetate, and hydroxyl group. Some exemplary examples of organic compounds that may be used are phenanthrene, glycine, maltose, glycine, dimethyl oxalate, and glucose. The organic compound may be a monomer, oligomer or polymer.

The organic compound may be an acid, such as a monoacid, diacid, or tri-acid or a mixture thereof. The monoacid comprises at least two carbon atoms and a single carboxylic acid group, the diacid comprises at least two carbon atoms and two carboxylic acid groups, and the triacid comprises at least three carbon atoms and three carboxylic acid groups. Other higher order acids may be used where the acid may comprise four or more carbon atoms and four or more carboxylic acid groups. The organic monoacids, diacids, and triacids may comprise at least one linear or branched alkyl chain. The organic acid may be a fatty acid.

Suitable organic acids include: Adipic acid, Arachidic acid, Ascorbic acid, Azelaic acid, Behenic acid, Benzoic acid, Benzoic acid, Cinnamic acid, Citric acid, Doconic acid, Doconosenoic acid, Docosanoic acid, Dotriacontanoic acid, Eicosanoic acid, Fumaric acid, Fumaric acid, Gallic acid, Glutaric acid, Glycolic acid, Hectanoylic acid, Heneicontanoic acid, Heneicosaenoic acid, Heptadecanoic acid, Heptaecontanoic acid, Heptaeicosaenoic acid, Heptapentacontanoic acid, Heptatriacontanoic acid, Hexacosanoic acid, Hexadecanoic acid, Hexaecontanoic acid, Hexaeicosaenoic acid, Hexapentacontanoic acid, Hexatriacontanoic acid, Lactic acid, Lauric acid, Maleic acid, Maleic acid, Malonic acid, Mandelic acid, Myristic acid, Nonadecanoic acid, Nonaecontanoic acid, Nonaicosaenoic acid, Nonapentacontanoic acid, Nonatriacontanoic acid, Octacosanoic acid, Octadecanoic acid, Octaecontanoic acid, Octaeicosaenoic acid, Octapentacontanoic acid, Octatriacontanoic acid, Oleic acid, Oxalic acid, Palmitic acid, Pentacontanoic acid, Pentacontenoic acid, Pentadecanoic acid, Pentaeicosaenoic acid, Pentatetracontanoic acid, Phthalic acid, Pimelic acid, Salicylic acid, Sebacic acid, Sorbic acid, Stearic acid, Suberic acid, Succinic acid, Succinic acid, Tartaric acid, Tetracontanoic acid, Tetracosanoic acid, Tetradecanoic acid, Tetraecontanoic acid, Tetraeicosaenoic acid, Tetrahexacontanoic acid, Tetrapentacontanoic acid, Tetratriacontanoic acid, Triacontanoic acid, Tricontanoic acid, and Tridecanoic acid

An organic monoacid may be ethanoic acid, propanoic acid, decanoic acid, benzoic acid, stearic acid, xylonic acid, threonic acid, ascorbic acid, 2,3-diketogulonic acid, or butyric acid or other similar monoacids or mixtures thereof. An organic diacid may be oxalic acid, malonic acid, succinic acid, glutaric acid, adipic acid, maleic acid, fumaric acid, phthalic acid, isophthalic acid, terephthalic acid, or other similar diacids or mixtures thereof. An organic triacid may be citric acid, isocitric acid, acontic acid, propane-1,2,3-tricarboxylic acid, agaric acid, trimesic acid, or other similar triacids or mixtures thereof.

The organic acid may also be a carbohydrate. Suitable carbohydrdates include: 2-Deoxy-D-galactose, 2-Deoxy-D-glucose, Agarose, Alginate, Allose, Altrose, Amylopectin, Amylose, Arabinogalactan, Carrageenan, Cellulose, Chitin, Chitosan, Chondroitin sulfate, Cyclodextrin, D-Arabinose, D-Cellobiose, D-Fructose, D-Galactosamine, D-Galactose, D-Glucosamine, D-Glucose, D-Lactose, D-Maltose, D-Mannitol, D-Mannose, D-Melezitose, D-Raffinose, D-Ribose, D-Sorbitol, D-Sucrose, D-Trehalose, D-Xylose, Dermatan sulfate, Dextran, Erythritol, Fructooligosaccharides, Fructose 1-phosphate, Fructose 6-phosphate, Fucoidan, Fucose, Galactosamine 1-phosphate, Galactosamine 6-phosphate, Galactose, Galacturonic acid, Glucose 1-phosphate, Glucose 6-phosphate, Glucuronic acid, Glucuronic acid lactone, Glycogen, Glycosaminoglycans, Guar gum, Gulose, Heparan sulfate, Heparin, Hyaluronic acid, Idose, Inositol, Inulin, Isomalt, Isomaltulose, Keratan sulfate, Lactitol, Locust bean gum, Maltitol, Maltodextrin, Mannan, Mannitol hexaacetate, Mannose, Mannose 1-phosphate, Mannose 6-phosphate, Mannuronic acid, N-Acetylgalactosamine, N-Acetylgalactosaminuronic acid, N-Acetylglucosamine, N-Acetylglucosamine 1-phosphate, N-Acetylglucosamine 1-phosphate lactone, N-Acetylglucosamine 6-phosphate, N-Acetylglucosamine 6-phosphate lactone, N-Acetylglucosaminuronic acid, N-Acetylmannosamine, N-Acetylmannosamine 1-phosphate, N-Acetylmannosamine 1-phosphate lactone, N-Acetylmannosamine 6-phosphate, N-Acetylmannosamine 6-phosphate lactone, N-Acetylmuramic acid, N-Acetylneuraminic acid, N-Acetylneuraminuronic acid, Palatinose, Pectin, Polydextrose, Ribitol, Ribose 5-phosphate, Starch, Tagatose, Talose, Trehalose dihydrate, Xanthan gum, Xyloglucan, and Xylose 5-phosphate.

The organic compound may also be an amino acid. Suitable amino acids include the common amino acids, namely Alanine, Arginine, Asparagine, Aspartic acid, Cysteine, Glutamic acid, Glutamine, Glycine, Histidine, Isoleucine, Leucine, Lysine, Methionine, Phenylalanine, Proline, Serine, Threonine, Tryptophan, Tyrosine, and Valine

The organic compound may also be an amide. Suitable amides include: Acetanilide, N-Methylacetamide, N-Ethylacetamide, N-Isopropylacetamide, N-Butylacetamide, and Oxamide.

Currently, the following organic compounds are preferred:
a) Dicarboxylic Acids, including Oxalic acid, Glutaric Acid, Adipic Acid, Ascorbic Acid, Suberic Acid, Azelaic Acid, and Sebacic Acid
b) Esters of Dicarboxylic Acids, including Diethyl Oxalate, Dimethyl Oxalate, Dipropyl Oxalate, Diethyl Malonate, and Dimethyl Malonate.
c) Amino Acids, including Glycine.
d) Amides, including Oxamide
e) Carbohydrates, including Glucose, Fructose, Xylose, Maltose, Trehalose, Sorbitol, Mannitol, Maltodextrin, Raffinose, and Amylose
f) Other Organic Acids, including Citric Acid, Ascorbic Acid, Butyric Acid, Valeric Acid, Hexanoic acid, Octanoic acid, Oleic acid, and Stearic Acid.

In some embodiments, a portion of water is added to the organic acid before or during heating of the organic acid. In some instances, only a trace of water is added. In other instances, water is added in the range of about 0.001 to about 40 weight % of the mass of the organic acid. The water may be 0.001% to about 35 weight %, or 0.001 to about 30%, or 0.001 to about 25%, or still about 0.001 to about 20%, or preferably about 0.001 to about 10 weight % of the organic acid. In one embodiment, which uses oxalic acid, the water is added to ensure formation of the dihydrate. This is preferred because the dihydrate of oxalic acid has a lower melting point, i.e., 101.5° C., compared to the melting point of anhydrous oxalic acid, i.e., 189 to 191° C.

The lithium compound has a general formula of LiₓA wherein x is 1-3 and where A is an anionic component. The metal compound has a general formula of MAₓ wherein x is 1 or 2 and where A is an anionic component. The lithium and metal compounds may be pre-mixed before addition to the organic compound or may be added in a sequential manner. The addition of the compounds may be added in one portion or may be added over a predetermined period of time.

The anionic component (A) in the lithium and metal compounds is selected from the group consisting of hydroxide, carbonate, acetate, alkoxide, oxalate, nitrate, nitride, sulfate, acetylacetonate, and oxide. A mixture of one or more lithium and metal compounds with different anionic components (A) may be added to the heated mixture or only a single anionic component may be added. The lithium and metal compounds may have the same or different anionic components.

The metal component M in the metal compound may preferably be Ni, Mn, or Co. The metal component in the form of metal ions such as Ni(II), Mn(II), or Co(II) may be coordinated by one or more organic mono-, di-, or tri-acids or other functional groups. The organic compound may aid in dissolving and homogenously dispersing the metal ion when the organic compound is melted. The metal component may also be selected from the group consisting of aluminum (Al), titanium (Ti), iron (Fe), vanadium (V), magnesium (Mg), niobium (Nb), zirconium (Zr), tungsten (W), tantalum (Ta), and boron (B).

In some embodiments, one or more optional dopants may be added to the mixture. The dopant is preferably a transition metal in ionic form. The dopant may be selected from the group consisting of aluminum (AI), titanium (Ti), zirconium (Zr), magnesium (Mg), boron (B), fluorine (F), W, molybdenum (Mo), V, Ta, gallium (Ga), niobium (Nb), zinc (Zn), cesium (Cs), and calcium (Ca). The one or more dopants preferably replaces a portion of the metal component in the lithium metal oxide.

In some embodiments, the lithium and metal compounds may be mixed and then the mixture may then be added to the organic compound.

A stoichiometric excess of the lithium compound may be added to the heated mixture. This is to make up for any lithium that may sublimate and be lost during the calcining step. An excess of lithium may also be desired such as when a battery cell proceeds through a formation process. Excess lithium may be beneficial to aid in the initial formation of the solid-electrolyte interphase (SEI) layer during the formation process and during continual cycling.

In some embodiments, recycled cathode, recycled metal hydroxide, or recycled metal oxide may be used as a feed material source for the metal component for the production of lithium metal oxides, lithium mixed metal oxides, and lithium metal phosphates described herein. For example, the feed material source may be collected from recycling of lithium metal batteries or from other industrial sources. In order to balance the stoichiometry, virgin metal oxides or metal hydroxides may be added to the recycled metal oxides or metal hydroxides synthesis to maintain a target stoichiometry.

As illustrated for this embodiment, the next step 104 in method 100 to manufacture a lithium metal oxide is to mill and grind the various compounds to form a first milled mixture. Milling may be done in a jet mill flowing nitrogen, argon or dry air. The milling pressure may be between 80-120 pounds per square inch. Milling may be in a jar with milling media. The jar may comprise a ceramic material or metallic material. The ceramic material may be yttria stabilized zirconia (YSZ). The milling media may comprise a ceramic material such as YSZ or a metal such as a high-grade steel. The compounds may be milled for a period of time in the range of about 10 min to up to about 10 hours. The mill jar may be rotated in a range of about 100-500 rpm, or in a range of about 200-400 rpm.

After milling, the next step 106 in method 100 comprises calcining the first milled mixture to form a first calcined mixture. The first calcining may be completed in a furnace, such as a tube furnace, atmosphere-controlled muffle furnace, or a rotary calciner. A shuttle calciner or a box calciner may also be utilized.

A first calcining process may comprise the following steps:
a) placing the first milled mixture in a calciner or furnace;
b) heating the solid to about 125-175° C. at a ramp rate of about 0.5 to about 30° C./min and holding for about 0.5 to 10 hours;
c) heating the solid to about 200-300° C. at a ramp rate of about 0.25 to about 15° C./min and holding for about 0.5 to about 10 hours;
d) heating the solid to about 300-400° C. at a ramp rate of up to about 0.25 to about 10° C./min and holding for about 0.5 to 10 hours; and
e) heating the solid to about 500-600° C. at a ramp rate of up to about 0.25 to about 10° C./min and holding for about 0.5 to 10 hours to form a first calcined mixture.

The first calcined mixture may then be cooled to below about 60° C. After cooling the mixture, the first calcined mixture is preferably milled to form a second milled mixture 108. The second milled mixture is then calcined a second time 110 and cooled to below about 60° C. to form a lithium metal oxide.

A second calcining process may comprise heating to about 900-1000° C. at a ramp rate of up to about 0.25 to about 10° C./min and holding for about 0.5 to 10 hours. In some embodiments, a single calcining process may be used from room temperature to 900-1000° C. at a ramp rate of up to about 0.25 to about 30° C./min.

The solid is preferably calcined in an atmosphere that includes oxygen. The atmosphere may be air or oxygen. The atmosphere may be a gas that comprises oxygen such as a mixture of nitrogen or argon and oxygen.

In some embodiments, a milling step is not used after the mixing step wherein after mixing the organic compound, lithium compound and one or more transition metal compounds and optional dopants are directly added to a calciner for calcination.

Other heat treatment methods may be used in the calcining process to produce the cathode materials described herein, such as flame pyrolysis, plasma pyrolysis, or dynamic recrystallization process. The heat treatment process may also comprise a multi-stage processing system to convert one or more precursor compounds into a cathode material wherein the system comprises a mist generator, a drying chamber, one or more gas-solid separators, and one or more in-line reaction modules further comprising one or more gas-solid feeders, one or more gas-solid separators, and one or more reactors.

The lithium metal oxide is then cooled to below about 60° C. and milled 112 to form a particulate lithium metal oxide that is preferably suited to be used as a cathode material in a lithium-ion battery. The lithium metal oxide may have the general formula LiMₓO_{y} wherein M is manganese, nickel, or cobalt and wherein x is 1 or 2 and wherein y is 2 or 4. The lithium metal oxide may have a spinel or layered structure. The lithium metal oxide may be polycrystalline or single crystalline or a combination thereof.

The lithium metal oxide may be comminuted such as by grinding and/or milling. The comminuted or non-comminuted lithium metal oxide may be sized to produce a particulate lithium metal oxide having a predetermined average particle size. The particle sizing may be carried out by a variety of particle separation methods. The lithium metal oxide preferably has an average particle size in the range of about 0.1 to 100 microns, or more preferably in the range of about 1 to 10 microns, or even more preferably in the range of about 2 to 5 microns.

In some embodiments, a coating or layer may be further deposited onto the surface of the lithium metal oxide formed by the one-pot methods disclosed herein. The coating can influence particle interfacial properties in beneficial ways. The coating can also prevent the cathode materials from direct contact with the electrolyte and avoid decomposition or oxidation of the electrolyte which leads to improved cycle and storage life of the battery. The coating may comprise a metal oxide such as Al₂O₃, ZrO₂, TiO₂, B₂O₃, MoO₃, or WO₃. The coating may also comprise a phosphate, fluorides such as AlF₃, MgF₂, CeF₂, or CaF₂, or conducting polymer. The coating may also comprise a solid electrolyte. The coating may comprise a fast ionic conductor such as LiAlO₂, Li₃ZrO₂, Li₂O—2B₂O₃, Li₃PO₄, Li₂ZrO₃, or Li₂WO₄. The coating may also comprise a second lithium metal oxide material.

A coating may be deposited onto the lithium metal oxide such as by dispersing in a solution of the coating precursor materials or be tumbled with solid precursor materials. In both methods, the lithium metal oxides with the coating of precursor materials are then calcined to form a coating on the surface. The coating may be a continuous or non-continuous coating. The coating may have a thickness in the range of preferably about 1 to about 100 nm, more preferably about 1 to about 50 nm or even more preferably about 1 to about 20 nm.

In an embodiment, the lithium metal oxide may be dispersed in a solution comprising coating precursor materials to form a dispersion. The dispersion may be dried, such as by spray drying to flash dry the lithium metal oxide particles with a uniform coating of precursor materials. The particles may then be calcined to form an adhered coating on the surface.

In another method to form a coating on the lithium metal oxide surface, the lithium metal oxide may be tumbled with solid precursor materials followed by calcining to form a surface layer. In one specific example, forming the outer layer of Li and Co-rich material on the lithium metal oxide surface comprises tumbling the metal oxide with Li and Co-containing precursor materials to form a coated lithium metal oxide; and then calcining the coated lithium metal oxide to form a lithium metal oxide with a Li and Co-rich layer such that the Co does not substantially enter the structure of the metal oxide portion.

### Lithium Mixed Metal Oxides

The following embodiments relate to a method to manufacture a mixed metal oxide, in particular a lithium mixed metal oxide. The lithium mixed metal oxide may be single crystalline or polycrystalline.

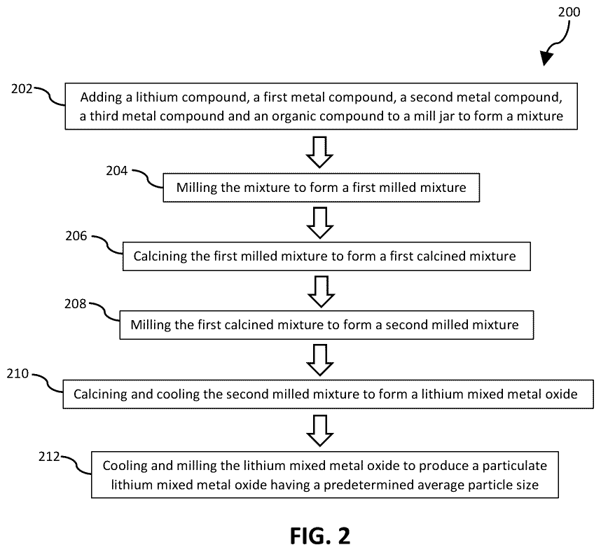

FIG. 2 is a block diagram of a method 200 to manufacture a particulate lithium mixed metal oxide, according to an embodiment of the disclosure. This method 200 is similar to method 100 but the organic compound, lithium compound, and two or more metal compounds, and one or more optional dopants may be added together in a desired stoichiometry to form a mixture 202. Method 200 comprises using three different metal compounds for illustration purposes. A 0.01-50% molar concentration of organic compounds to metal compounds may be used. The mixture is milled to form a first milled mixture 204. The first milled mixture is calcined 206 using a similar process to the first calcining process 106 in method 100.

The calcined mixture is cooled to below about 60° C. and milled to form a second milled mixture 208.

The second calcining process 210 may comprise heating to about 900-1000° C. at a ramp rate of up to about 0.25 to about 10° C./min and holding for about 0.5 to 10 hours. The mixture is then cooled to about room temperatures, or at least below about 60° C. to yield a lithium mixed metal oxide. The lithium mixed metal oxide may have the formula Li(M1)ₓ(M2)₁₋ₓO₂ and may optionally be comminuted and sized to produce a particulate lithium mixed metal oxides having a predetermined average particle size 212.

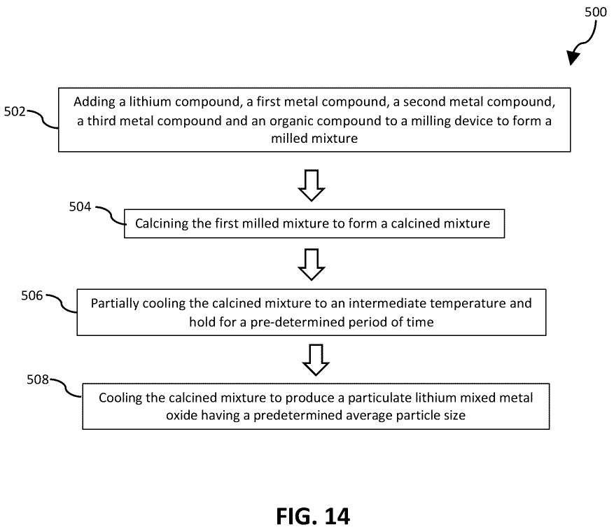

FIG. 14 is a block diagram of an alternative method 500 to manufacture a particulate lithium mixed metal oxide, according to an embodiment of the disclosure. This method 500 is similar to methods 100 and 200. This method does not use an intermediate milling step as in steps 108 and 208. Instead, an additional calcination step of 600-800° C. may be used after the 900-1000° C. calcination step is completed. For example, after reaching the 900-1000° C. temperature range, the calciner may be partially cooled to an intermediate annealing temperature range of about 600-800° C. and held for a pre-determined period of time in the range of about 0.25-10 hours after which the calcined mixture is cooled to room temperature or at least to about 60° C. Method 500 comprises milling the mixture to form a milled mixture 502. The milled mixture is calcined 504 to form a calcined mixture. The calcined mixture is partially cooled 506 to an intermediate temperature of about 600-800° C. and held for a pre-determined period of time of about 0.25-10 hours. Cooling the calcined mixture to below about 60° C. 508 to form a particulate lithium mixed metal oxide have a predetermined particle size.

A calcining process according to this method may comprise the following steps:
a) placing the first milled mixture in a calciner or furnace;
b) heating the solid to about 100-175° C. at a ramp rate of about 0.5 to about 10° C./min and holding for about 0.5 to 5 hours;
c) heating the solid to about 500-600° C. at a ramp rate of about 0.5 to about 10° C./min and holding for about 0.5 to about 10 hours;
d) heating the solid to about 600-800° C. at a ramp rate of about 0.5 to about 10° C./min and holding for about 0.5 to 10 hours;
e) heating the solid to about 850-1000° C. at a ramp rate of about 0.5 to about 10° C./min and holding for about 0.5 to 10 hours;
f) cool the solid to about 600-800° C. at a ramp rate of about 0.5 to about 10° C./min and holding for about 0.25 to 10 hours; and
g) cool the calcined mixture to below about 60° C.

Another calcining process according to this method may comprise the following steps:
placing the mixture in a calciner;
heating the mixture to about 125-175° C. at a ramp rate of up to about 30° C./min and holding for about 0.5 to ten hours;
heating the mixture to about 200-300° C. at a ramp rate of up to about 15° C./min and holding for about 0.5 to ten hours;
heating the mixture to about 300-400° C. at a ramp rate of up to about 10° C./min and holding for about 0.5 to ten hours;
heating the mixture to about 500-600° C. at a ramp rate of up to about 10° C./min and holding for about 0.5 to about ten hours;
heating the mixture to about 700-800° C. at a ramp rate of up to about 10° C./min and holding for about 0.5 to about ten hours;
heating the mixture to about 900-1000° C. at a ramp rate of up to about 10° C./min and holding for about 0.5 to about ten hours;
cooling the mixture to about 600-800° C. at a ramp rate of up to about 10° C./min and holding for about 0.25 to about ten hours; and
cooling to below about 60° C.

Lithium mixed metal oxides with general formula Li(M1)ₐ(M2)_{b}(M3)_{c}O₂ wherein a+b+c=1 may also be synthesized using methods 100, 200 and 500.

Lithium mixed metal oxides with general formula Li(M1)ₐ(M2)_{b}(M3)_{c}(M4)_{d}O₂ wherein a+b+c+d=1 may also be synthesized using methods 100, 200 and 500. A fourth metal compound may be added wherein metals M1, M2, M3, and M4 are all different. Metals M1, M2, M3, and M4 may preferably be selected from the group consisting of nickel, manganese, cobalt, and aluminum. Metals M1, M2, M3, and M4 may also be selected from the group consisting of Al, Ti, Zr, Mg, B, F, W, Mo, V, Ta, Ga, Nb, and Ca.

One or more optional dopants may be added to the mixture for milling for any of the lithium mixed metal oxides. The dopant is preferably a transition metal in ionic form. The dopant may be selected from the group consisting of Al, Ti, Zr, Mg, B, F, W, Mo, V, Ta, Ga, Nb, Zn, Cs, and Ca.

The synthetic methods disclosed herein may further comprise a fluorine (F)-based reagent in the reaction mixture, such as NiF₂, CoF₂, MnF₂, LiF, or NH₄F. The fluorine atoms may be incorporated into the oxygen layer and replace some of the oxygen atoms. Metal oxide with fluorine incorporated may have the resulting formula of LiMO₂₋ₓFₓ where M comprises one or more of Mn, Ni, Co, and Al and where x<0.05. Lithium metal oxide cathodes with fluorine doped on the oxygen site may show improved thermal stability when the cathodes are charged to high voltages.

In some embodiments, any fraction of lithium metal oxide or lithium mixed metal oxide that is collected after a particle separation method is carried out wherein the particle size is too small or too large may be re-used for the synthesis of another batch of lithium metal or mixed metal oxide.

### Synthesis of LiNi_{0.8}Mn_{0.1}Co_{0.1}O₂ Using Various Organic Compounds

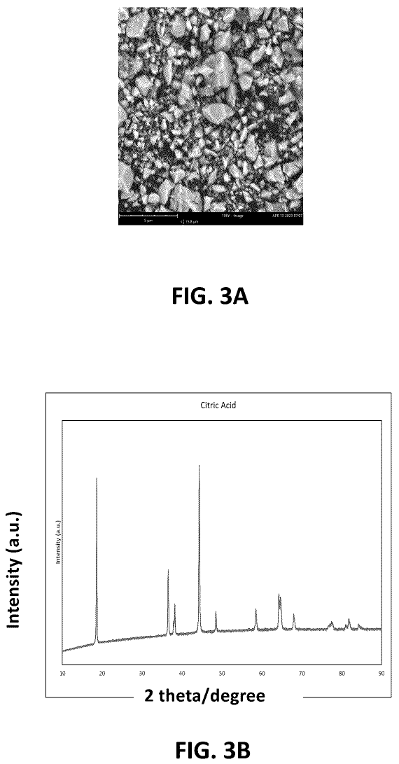

FIG. 3A is an SEM of particles of LiNi_{0.8}Mn_{0.1}Co_{0.1}O₂ 300 synthesized using method 200. The method used citric acid as the organic compound. The particles are single particles that do not show any agglomeration.

FIG. 3B is the XRD pattern of LiNi_{0.8}Mn_{0.1}Co_{0.1}O₂ 300 synthesized using method 200. The XRD shows pure phase LiNi_{0.8}Mn_{0.1}Co_{0.1}O₂ has been formed.

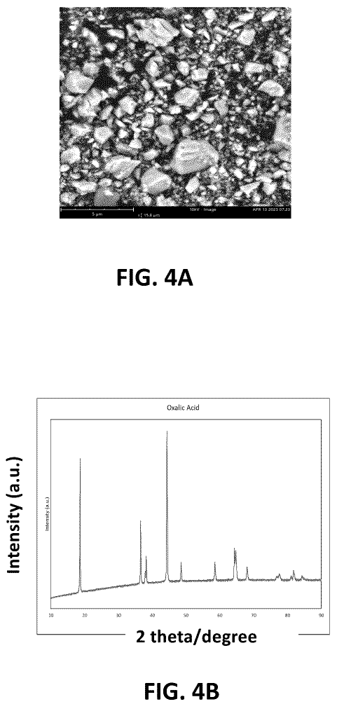

FIG. 4A is an SEM of particles of LiNi_{0.8}Mn_{0.1}Co_{0.1}O₂ 302 synthesized using method 200. The method used oxalic acid as the organic compound. The particles are single particles that do not show any agglomeration.

FIG. 4B is the XRD pattern of LiNi_{0.8}Mn_{0.1}Co_{0.1}O₂ 302 synthesized using method 200. The XRD shows pure phase LiNi_{0.8}Mn_{0.1}Co_{0.1}O₂ has been formed.

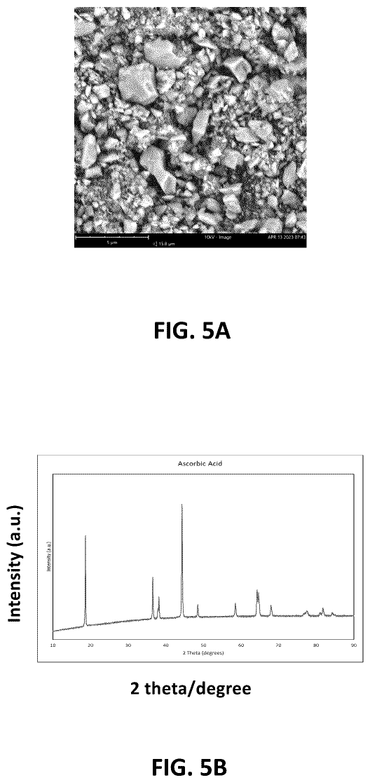

FIG. 5A is an SEM of particles of LiNi_{0.8}Mn_{0.1}Co_{0.1}O₂ 304 synthesized using method 200. The method used ascorbic acid as the organic compound. The particles are single particles that do not show any agglomeration.

FIG. 5B is the XRD pattern of LiNi_{0.8}Mn_{0.1}Co_{0.1}O₂ 304 synthesized using method 200. The XRD shows pure phase LiNi_{0.8}Mn_{0.1}Co_{0.1}O₂ has been formed.

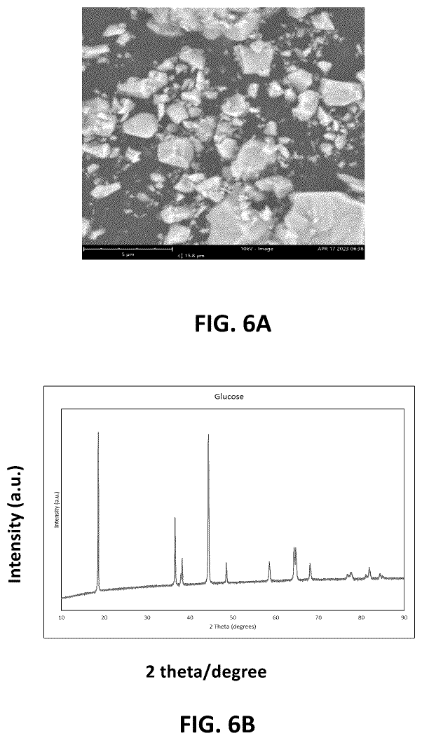

FIG. 6A is an SEM of particles of LiNi_{0.8}Mn_{0.1}Co_{0.1}O₂ 306 synthesized using method 200. The method used glucose as the organic compound. The particles are single particles that do not show any agglomeration.

FIG. 6B is the XRD pattern of LiNi_{0.8}Mn_{0.1}Co_{0.1}O₂ 306 synthesized using method 200. The XRD shows pure phase LiNi_{0.8}Mn_{0.1}Co_{0.1}O₂ has been formed.

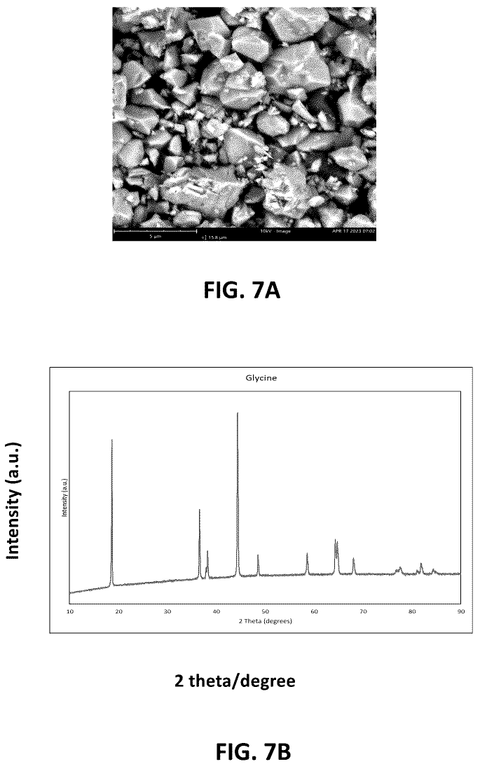

FIG. 7A is an SEM of particles of LiNi_{0.8}Mn_{0.1}Co_{0.1}O₂ 308 synthesized using method 200. The method used glycine as the organic compound. The particles are single particles that do not show any agglomeration.

FIG. 7B is the XRD pattern of LiNi_{0.8}Mn_{0.1}Co_{0.1}O₂ 308 synthesized using method 200. The XRD shows pure phase LiNi_{0.8}Mn_{0.1}Co_{0.1}O₂ has been formed.

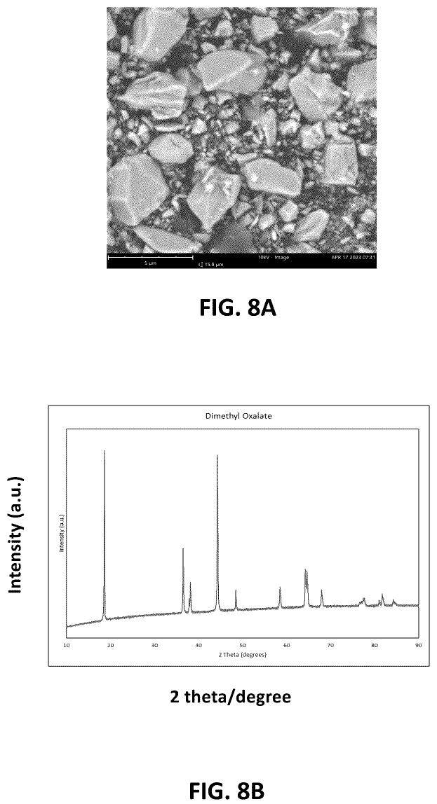

FIG. 8A is an SEM of particles of LiNi_{0.8}Mn_{0.1}Co_{0.1}O₂ 310 synthesized using method 200. The method used dimethyl oxalate as the organic compound. The particles are single particles that do not show any agglomeration.

FIG. 8B is the XRD pattern of LiNi_{0.8}Mn_{0.1}Co_{0.1}O₂ 310 synthesized using method 200. The XRD shows pure phase LiNi_{0.8}Mn_{0.1}Co_{0.1}O₂ has been formed.

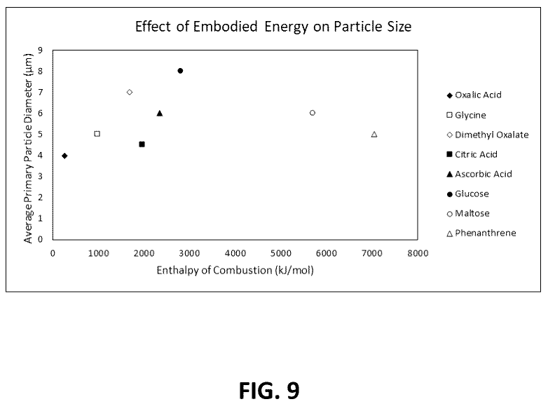

From the various organic compounds used in the synthesis of LiNi_{0.8}Mn_{0.1}Co_{0.1}O₂, it is observed that the embodied energy (enthalpy of combustion, kJ/mol) in the organic compounds appears to play a role on the average primary particle diameter. FIG. 9 is a plot of the effect of enthalpy of combustion of the organic compound on average primary particle diameter for LiNi_{0.8}Mn_{0.1}Co_{0.1}O₂. As the enthalpy of combustion increases for the organic compound used in the synthesis of LiNi_{0.8}Mn_{0.1}Co_{0.1}O₂, the average primary particle diameter also increases. This may be due to localized heating during the calcining step.

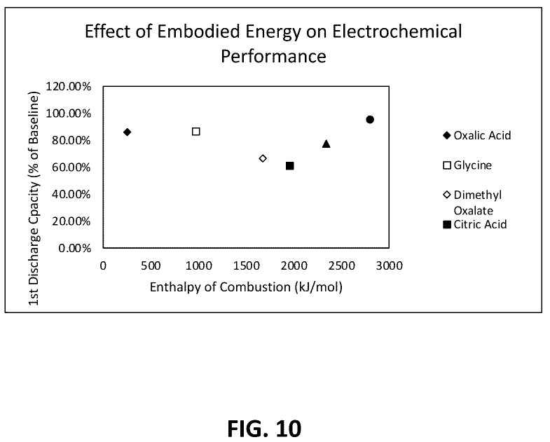

FIG. 10 shows the effect of the embodied energy of several organic compounds on the 1st discharge capacity of synthesized LiNi_{0.8}Mn_{0.1}Co_{0.1}O₂. Tests were completed using 2032 sized coin cell batteries.

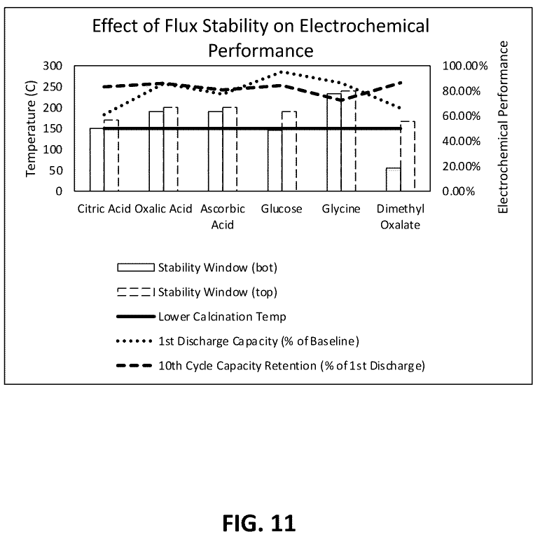

The effect of flux stability of the organic compounds used in the synthesis of LiNi_{0.8}Mn_{0.1}Co_{0.1}O₂ on the electrochemical performance was completed and is illustrated in FIG. 11. The bottom stability window is the temperature where the organic compound melts and the top stability window is the temperature where the organic compound combusts. The 10^{th} cycle capacity data was determined using 2032 size coin cell batteries.

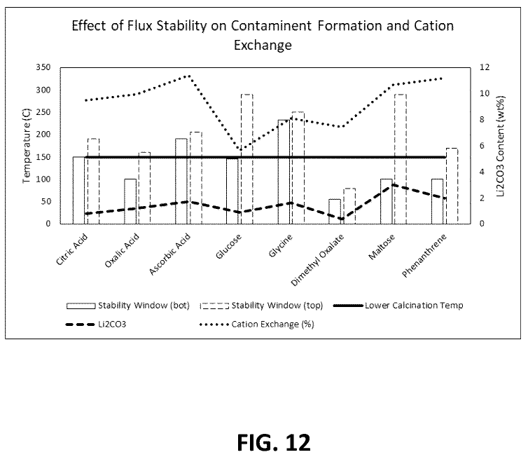

The effect of flux stability of the organic compounds used in the synthesis of LiNi_{0.8}Mn_{0.1}Co_{0.1}O₂ on the contaminant formation and cation exchange was completed and is illustrated in FIG. 12.

Table 1 lists the various parameters and resulting powder characteristics of the LiNi_{0.8}Mn_{0.1}Co_{0.1}O₂ synthesized using method 500.

TABLE 1

| | | | | | Cation | | | | Median |
|---|---|---|---|---|---|---|---|---|---|
| | | | Additive | | Exchange | | | | Primary |
| | LiNi0.8Mn0.1Co0.1O2 | Organic | Conc | Calcining | (% Ni in | | | | Particle |
| Example # | Sample # | Additive | (mol %) | Method | Li layer) | D10 | D50 | D90 | Size (um) |
| 10 | 520 | ascorbic acid | 50 | Method 500 | 7.69 | 7.72 | 25.16 | 70.59 | 0.84 |
| 11 | 522 | maleic acid | 10 | without an | 5.39 | 2.83 | 15.81 | 42.44 | 1.01 |
| 12 | 524 | tartaric acid | 10 | intermediate | 6.03 | 2.48 | 14.28 | 34.14 | 1.13 |
| 13 | 526 | phenanthrene | 5 | cooling step | 5.39 | 2.49 | 12.87 | 29.65 | 0.89 |
| 14 | 528 | ascorbic acid | 10 | | 8.81 | 5.09 | 34.43 | 140.94 | 1.24 |
| 15 | 530 | ascorbic acid | 5 | | 8.71 | 4.94 | 26.38 | 84.44 | 0.95 |
| 16 | 532 | oxamide | 50 | | 6.58 | 10.67 | 37.26 | 99.56 | 0.92 |
| 17 | 534 | glucose | 10 | | 7.21 | 5.23 | 35.09 | 132.72 | 0.84 |
| 18 | 536 | oxamide | 5 | | 4.66 | 2.34 | 21.48 | 118.70 | 1.01 |
| 19 | 538 | oxalic acid | 5 | | 2.39 | 2.21 | 20.54 | 72.24 | 0.94 |
| 20 | 540 | suberic acid | 10 | | 5.36 | 7.22 | 31.60 | 120.37 | 0.71 |
| 21 | 542 | sucrose | 50 | | 11.06 | 10.89 | 32.85 | 89.31 | 0.73 |
| 22 | 544 | stearic acid | 10 | | 3.13 | 3.24 | 18.18 | 35.21 | 1.04 |
| 23 | 546 | sucrose | 5 | | 7.08 | 2.67 | 24.80 | 58.25 | 0.70 |
| 24 | 548 | oxalic acid | 50 | | 6.61 | 1.80 | 30.32 | 209.43 | 0.95 |
| 25 | 550 | ascorbic acid | 10 | | 6.26 | 3.53 | 23.44 | 42.80 | 0.84 |
| 26 | 552 | phenanthrene | 50 | | 6.33 | 1.33 | 16.26 | 57.47 | 0.91 |
| 27 | 554 | oxalic acid | 5 | Method 500 | 0.18 | 0.55 | 1.69 | 20.03 | 1.42 |
| 28 | 556 | oxalic acid | 10 | | 0.00 | 0.36 | 2.81 | 26.53 | 2.77 |
| 29 | 558 | oxamide | 10 | | 1.64 | 0.34 | 3.68 | 15.38 | 1.59 |
| 30 | 560 | sucrose | 10 | | 1.73 | 0.46 | 2.26 | 16.87 | 1.93 |
| 31 | 562 | suberic acid | 10 | | 0.41 | 0.38 | 2.52 | 19.39 | 2.13 |
| 32 | 564 | linoleic acid | 10 | | 0.76 | 0.38 | 3.54 | 23.51 | 1.06 |
| 33 | 566 | none | — | | 2.11 | 0.66 | 4.78 | 9.74 | 1.24 |

Table 2 lists the various parameters and resulting electrochemical properties of the LiNi_{0.8}Mn_{0.1}Co_{0.1}O₂ synthesized using method 500.

TABLE 2

| | | | | | Avg. | Std | Avg. | Std | |
|---|---|---|---|---|---|---|---|---|---|
| | | | Additive | | First | First | First | First | Avg. |
| | LiNi0.8Mn0.1Co0.1O2 | Organic | Conc | Calcining | Chg | Chg | Dis | Dis | FCE |
| Example # | Sample # | Additive | (mol %) | Method | (mAh/g) | (mAh/g) | (mAh/g) | (mAh/g) | (%) |
| 10 | 520 | ascorbic acid | 50 | Method 500 | 213.80 | 4.37 | 157.50 | 3.47 | 73.67% |
| 11 | 522 | maleic acid | 10 | without an | 217.32 | 1.87 | 163.88 | 2.63 | 75.41% |
| 12 | 524 | tartaric acid | 10 | intermediate | 203.14 | 3.91 | 153.84 | 3.10 | 75.73% |
| 13 | 526 | phenanthrene | 5 | cooling step | 207.35 | 3.10 | 155.94 | 2.82 | 75.20% |
| 14 | 528 | ascorbic acid | 10 | | 200.52 | 2.10 | 151.86 | 2.27 | 75.74% |
| 15 | 530 | ascorbic acid | 5 | | 210.97 | 0.76 | 163.14 | 1.03 | 77.33% |
| 16 | 532 | oxamide | 50 | | 197.13 | 3.72 | 156.48 | 4.06 | 79.38% |
| 17 | 534 | glucose | 10 | | 212.50 | 1.82 | 160.21 | 4.67 | 75.39% |
| 18 | 536 | oxamide | 5 | | 220.70 | 4.98 | 183.84 | 1.63 | 83.30% |
| 19 | 538 | oxalic acid | 5 | | 234.69 | 1.51 | 195.75 | 1.58 | 83.41% |
| 20 | 540 | suberic acid | 10 | | 239.89 | 10.82 | 197.35 | 9.54 | 82.27% |
| 21 | 542 | sucrose | 50 | | 159.13 | 8.52 | 95.92 | 6.19 | 60.28% |
| 22 | 544 | stearic acid | 10 | | 217.37 | 1.44 | 172.87 | 1.58 | 79.53% |
| 23 | 546 | sucrose | 5 | | 205.54 | 3.93 | 164.58 | 3.74 | 80.07% |
| 24 | 548 | oxalic acid | 50 | | 236.33 | 8.42 | 164.21 | 11.04 | 69.48% |
| 25 | 550 | ascorbic acid | 10 | | 206.45 | 3.19 | 165.57 | 2.51 | 80.20% |
| 26 | 552 | phenanthrene | 50 | | 195.90 | 4.73 | 150.48 | 3.53 | 76.81% |
| 27 | 554 | oxalic acid | 5 | Method 500 | 226.00 | 1.05 | 193.04 | 0.74 | 85.42% |
| 28 | 556 | oxalic acid | 10 | | 224.78 | 3.70 | 193.28 | 3.91 | 85.98% |
| 29 | 558 | oxamide | 10 | | 221.74 | 3.72 | 189.28 | 2.52 | 85.36% |
| 30 | 560 | sucrose | 10 | | 221.03 | 3.92 | 189.43 | 3.26 | 85.70% |
| 31 | 562 | suberic acid | 10 | | 221.95 | 2.09 | 184.34 | 1.57 | 83.05% |
| 32 | 564 | linoleic acid | 10 | | 216.77 | 1.39 | 182.72 | 2.61 | 84.29% |
| 33 | 566 | none | — | | 227.49 | 5.76 | 190.63 | 2.28 | 83.80% |

Thermogravimetric Analysis (TGA) was conducted under air flow on each of the organic additives in their pure states to verify the decomposition temperatures in an oxygenated environment. Enthalpy of combustion data was collected from publicly available research sources.

In examples 10-33 in Tables 1-2, powder x-ray diffraction (XRD) with Rietveld refinement and scanning electron microscopy (SEM) were conducted on each experimental sample 520-566 to assess the crystal structure, phase purity, and particle size and morphology. Primary particle size was measured using image analysis software (ImageJ) on SEM images of the samples. Particle size analysis was also performed using a laser diffraction particle size analyzer (Horiba LA960). Samples 520-552 were lightly hand milled before particle size analysis, while samples 554-566 were iteratively milled until the D90 particle size was reduced below 30 μm. The physical properties quantified were (003)/(104) peak ratio (which is related to structural ordering in NMC811), cation exchange (Li—Ni mixing, as calculated from Rietveld refinement of XRD data), D50 particle size (from particle size analysis), and median primary particle size (from image analysis).

Electrochemical testing for samples 520-566 was performed using coin half cells consisting of a lithium anode, a separator soaked with liquid electrolyte, and a cathode electrode made from cathode active material (CAM) powder (i.e., NMC811) cast onto carbon-coated aluminum foil. Cathode electrodes were made utilizing a mixture of CAM, a conductive additive (carbon black), and a polymer binder solution (12 wt % PVdF in NMP solvent) in a mass ratio of 85:7:8 CAM: carbon black: PVdF, along with additional solvent. Cells using samples 520-552 were cycled at a constant current charge and discharge rate of C/10 from 2.7V to 4.3Vat 30° C. with an 8 hour rest after assembly, while cells from samples 554-566 were cycled from 2.7V to 4.3V at 30° C. with an 8 hour rest after assembly using the following cycling protocol: 3 cycles at constant current charge and discharge rate of C/10 with a C/20 constant voltage hold at the top of charge and a 30 minute rest between cycles, 3 cycles each at rates of C/10-D/10, C/10-D/5, and C/10-D/3 with a 30 minute rest between cycles, and continued cycling at C/3-D/3 with a 30 minute rest between cycles. The electrochemical properties measured were: first charge capacity, irst discharge capacity, first cycle coulombic efficiency, cycles to 20% capacity loss (for samples 520-552 only), and capacity loss after C/10-D/3 cycling (for samples 554-566).

For each sample tested in Tables 1-2, physical and electrochemical property data were fed into statistical analysis software JMP and fitted using a least squares regression to identify trends between experimental variables (organic additive concentration, enthalpy of combustion, and decomposition temperature), and the measured physical and electrochemical properties.

The various organic additives shown in Tables 1-2 were chosen to span a wide design space of decomposition temperatures and enthalpies of combustion to determine the impact of these properties on the resulting LiNi_{0.8}Mn_{0.1}Co_{0.1}O₂ (NMC811) material. These examples show the impact of the organic additives on NMC811 synthesis using various heat treatment procedures. Examples 10-26 use a standard heat treatment procedure for the formation of single-crystal NMC811, which is known to require high temperature calcination for both phase formation and single crystal growth. Examples 27-33 use a modified procedure that includes a lower temperature intermediate annealing step after the high temperature calcination in order to reduce cation exchange and improve structural ordering in the NMC material. All of the examples 10-33 produced phase pure, single crystal NMC811 material.

While all samples synthesized were pure phase NMC811, the degree of structural ordering, the primary particle size, and the particle size distribution are all influential in achieving the desired electrochemical performance for the final cathode active material. Because of the importance of these factors, determining the effect of the organic additive on these properties allows for the tailoring of the conditions of the cathode synthesis process to target specific combinations that will yield beneficial electrochemical performance.

With respect to particle size, the two properties measured were the general particle size distribution (D10, D50, and D90 particle sizes), and the median primary particle size of the cathode material after synthesis. The first measurement is reflective of the primary particle size but also includes impacts from aggregation of the material that occurs during calcination as a result of the solid-solid reactions that create the NMC phase and grow the primary particles, as well as the effects of milling shatter primary particles. The second measurement is focused on the finer particles that make up the aggregates which impacts the stability and rate capability of the cathode material during cycling.

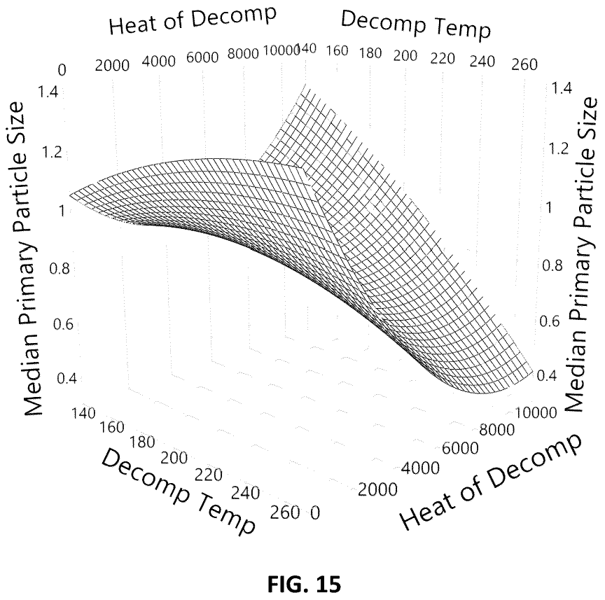

For examples 10-26, particle size of samples 520-552 was strongly impacted by enthalpy of combustion of the organic and its decomposition temperature, with concentration effects being statistically weaker than the other two factors. The response surface profile for median primary particle size as a function of enthalpy of combustion and decomposition temperature for an additive concentration of 0.1 moles additive per mole transition metal is displayed FIG. 15.

FIG. 15 is a plot of the response surface of samples 10-26. As can be seen in the response surface of samples 10-26, the largest primary particle sizes result from a combination of either high energy and low decomposition temperature or the inverse, while very high energy and decomposition temperature actually yielded a lower predicted particle size. In the case of the larger particle sizes, this result is consistent with theoretical models of crystal growth, which would indicate that particle fusion from the released energy or close particle contact resulting from mixing with the melted but not decomposed organic compound may increase solid-solid particle contact and promote crystal growth.

The behavior of high heat and high decomposition temperature materials is somewhat counterintuitive, but observation of the final cathode material resulting from these experiments provides a plausible mechanistic explanation. While the majority of samples 520-566 exited the furnace with a rocky texture made up of loosely-fused hard particles, the samples using the highest energy and most thermally stable organic additives displayed much more porous structure before milling, with large air pockets visible throughout the crucible. Considering that the additives that are both high in embodied energy and thermally stable tend to be large hydrocarbons that would generate a significant amount of gas (both carbon dioxide and water vapor) upon decomposition, it is believed that this gas evolution during decomposition creates porosity in the material that reduces the solid-solid contact necessary to induce the growth of larger single-crystal particles.

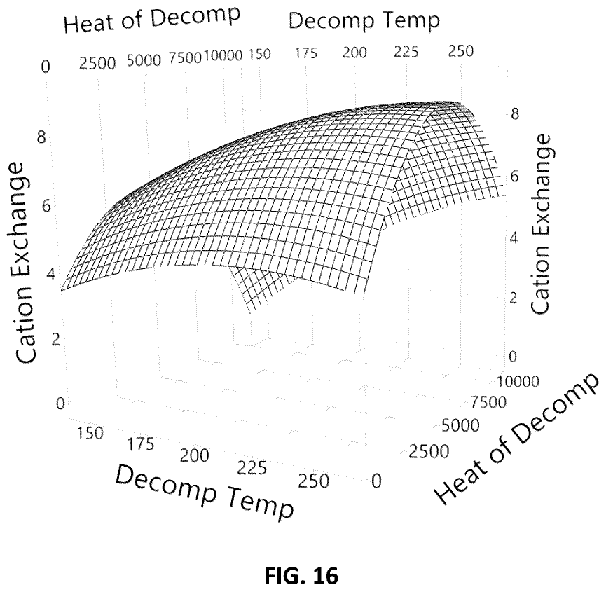

The effect of the organic additives on structural ordering showed similarly strong impacts from the temperature and energy of decomposition, with heat of combustion being the most influential single indicator for cation exchange. The response surface profile for cation exchange as a function of heat of combustion and decomposition temperature for a concentration of 0.1 moles of additive per mole of transition metal is displayed in FIG. 16. This case is illustrative of the general trend of the cation exchange response, with the heat of combustion creating a large curvature in the profile in which moderate heats yield the highest cation exchange (and thus higher disorder), while increasing decomposition temperatures yield greater levels of cation exchange for a given heat of combustion. This is possibly due to the fact that the maximum temperatures achieved during decomposition would be greater in these cases than those where the reaction occurred earlier in the thermal process, allowing the Li—Ni site exchange to occur more frequently. In the most extreme cases, it is possible that the decomposition of the organics may lead to the bed temperature exceeding the maximum temperature in the calcination profile for brief periods before the heat dissipates. The curvature of the profile with respect to heat of combustion may indicate that this increase in local heating upon decomposition is most detrimental to structural ordering when it heats the material to intermediate temperatures compared to either high or low enthalpy organics, especially considering the aforementioned preference for lower decomposition temperatures for low cation exchange.

The electrochemical performance of samples 520-566 was measured primarily through first cycle performance (charge capacity, discharge capacity, and first cycle coulombic efficiency) in coin cells. Measurements of cycle life were also conducted by cycling cells to 20% capacity loss, but due to the lower reliability of half-cells for accurately predicting cycling stability less weight was placed on this data.

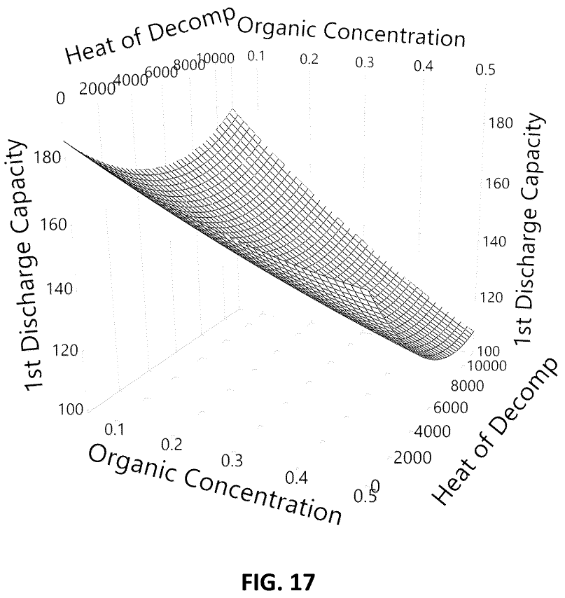

In the case of first cycle performance metrics, the strongest trend among the samples was that increasing additive concentration tended to reduce the electrochemical performance of the synthesized NMC811. An illustrative response surface profile for 1st discharge capacity as a function of organic concentration and heat of combustion is shown in FIG. 17 for additives with a decomposition temperature of 200° C.

While the strongest trend appears to be that of decreasing capacity with increasing heat of combustion, the more pronounced decrease at higher total energies (larger concentration of high heat organic) is suggestive of some possible mechanisms for this effect. As discussed above, the decomposition of the larger organic molecules (which have more embodied energy) may lead to porosity in the powder bed from the increase in gas evolution. In addition to reducing particle size, which may increase surface reactivity and promote impurity formation and side reactions during cycling, this reduced solid-solid contact during synthesis has the potential to increase heterogeneity and reduce performance. Furthermore, the increase in energy released during the combustion of the organic additive may promote structural disorder, providing the required energy to allow for more site exchange defects within the crystal structure. This would also be consistent with the increase in cation exchange for higher decomposition temperature organic additives at a given heat of combustion as discussed above.

Within samples 520-552 that used method 500 without an intermediate, lower temperature annealing step, the overall electrochemical performance was below the performance of baseline standards for NMC811, with over 50% of the samples showing 1st discharge capacities between 150-165 mAh/g compared to a target of 200 mAh/g for standard materials in lithium half-cells. As will be discussed with samples 554-566 using method 500 with an intermediate, lower temperature annealing step, much of this difference may be attributable to a combination of increased structural disorder compared to baseline materials and less controlled particle size distributions. However, samples 520-552 show initial electrochemical performance much closer to that of the baseline materials, indicating that the use of these additives under the right conditions may enable this simpler heat treatment process to be used for the production of high quality NMC811. The experimental conditions and electrochemical data for these samples is shown in Table 2.

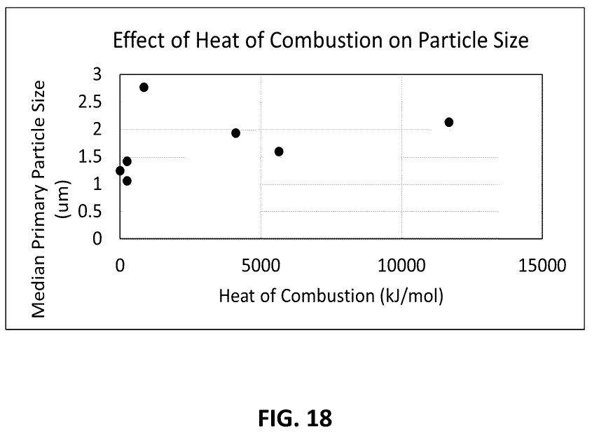

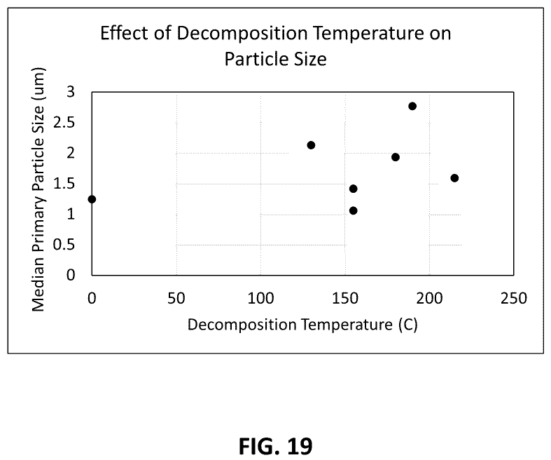

Samples 554-566 displayed noticeably less variation in electrochemical performance than samples 520-552, with all seven samples performing within a fairly similar range on first cycle charge, discharge, and coulombic efficiency as shown in Table 2. This data agrees well with the fact that the cation exchange for all seven samples 554-566 was significantly lower than those in samples 520-552, with all samples 554-566 showing less than 3% cation exchange and most showing less than 2%. This increase in structural ordering is the expected effect of the additional calcination step, and shows that any decrease in ordering resulting from the different organics can be remedied with this additional process step. Thus, in this new system the primary differentiator between the experimental samples results from particle size effects. The plots in FIGS. 18-19 show the median primary particle size of samples 554-566 as a function of both heat of combustion and decomposition temperature, respectively, of the organic additives. There are general trends of increasing particle size with increasing decomposition temperature and heat of combustion, with the heat of combustion being a stronger overall trend.

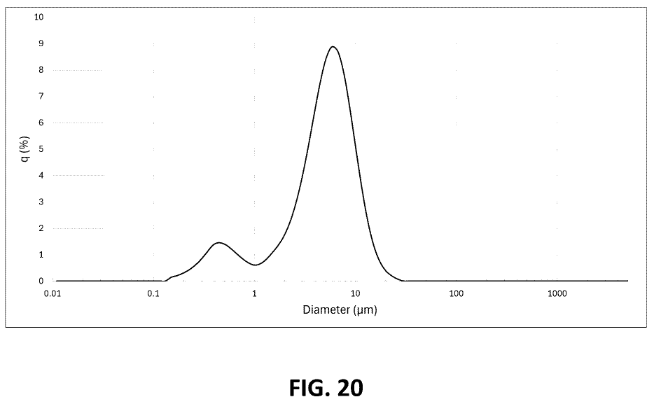

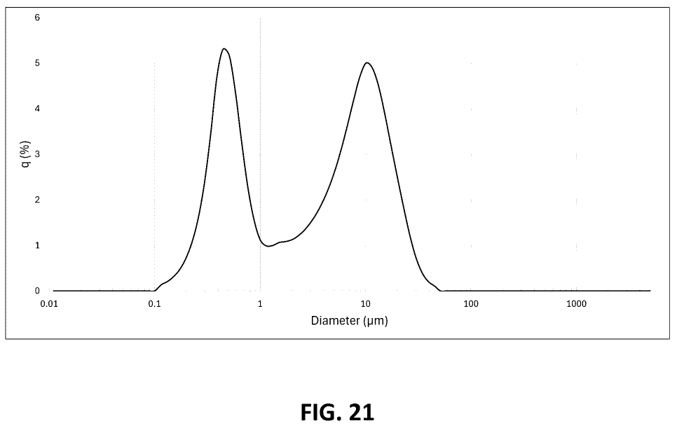

One influential factor may be the method used for milling the NMC811 material prior to particle size analysis. The materials were milled until the D90 as measured by the particle size analyzer was below 30 μm in order to reduce the effect of large aggregates on electrochemical performance. While this sort of post-processing is standard in NMC production, it does influence the experimental results, especially when comparing the sample without any organic additives to those with them, and is particularly evident when observing the particle size distribution charts like those shown in FIGS. 20 and 21. FIG. 20 is the particle size analysis of sample 566 with no organic additive. FIG. 21 is the particle size analysis of sample 560 using sucrose as the organic additive.

Because of the ability of the organic additive to help fuse particles together during decomposition, at the same time that the organic additive promotes crystal growth it also increases agglomeration of the crystalline particles by the same mechanism. Thus, in order to break down aggregates sufficiently to achieve adequate electrochemical performance, the material must be milled more aggressively than the material made without the organic additives, resulting in a more bimodal distribution of shattered fines and larger primary particles and small aggregate groups. It should be noted, however, that this effect may be reduced with more precise milling techniques such as those that include an in-line classification system to remove deagglomerated single crystals before they are shattered.

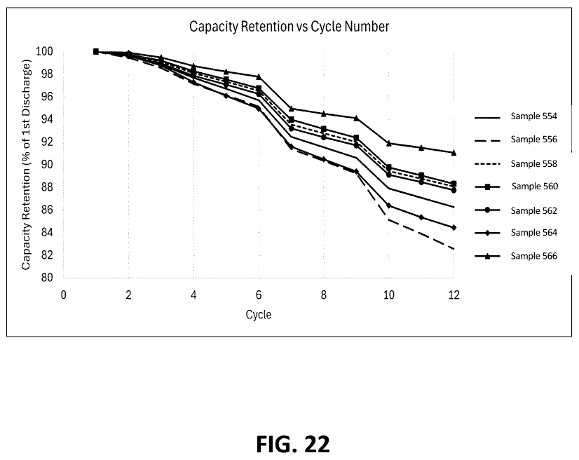

While these differences in particle size did not have a significant effect on the first cycle electrochemical performance metrics discussed above, the impact on cycling stability and rate capability is more evident. The plot in FIG. 22 is the capacity retention of samples 554-566 (compared to their first cycle discharge capacity) through the C/10 D/3 cycling step.

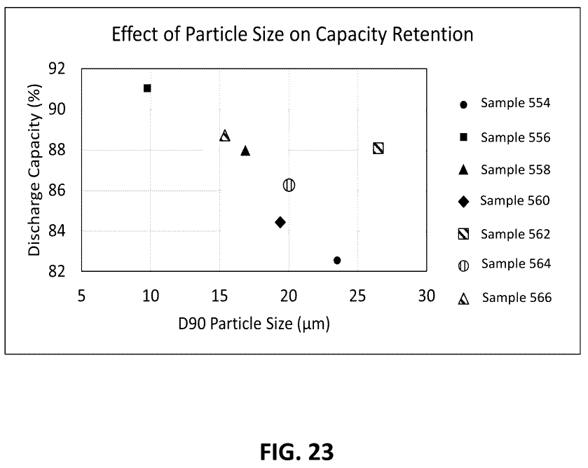

The divergence of these samples as the rate of discharge increases from D/10 to D/3 indicates that there are different levels of kinetic limitation on the lithium intercalation into the cathode material, which is consistent with the differences in particle size, especially for large particles. This is because as the particle size increases, the diffusion length for lithium increases. If the primary particles or particle aggregates grow too large, then the reaction is rate-limited by this longer diffusion length. This conclusion is further supported by the fact that a plot of capacity retention as a function of D90 particle size shown in FIG. 23 shows a fairly strong correlation between the two, with larger D90 particle sizes (indicating larger aggregates of single crystals) showing lower capacity retention at the end of this higher rate cycling.

The use of organic additives as a method for altering the properties of NMC811 synthesized through a solid-state process from transition metal oxides shows promise as an experimental tool. When used in conjunction with a simplified calcination process, the additives showed an ability to influence both particle size and structural ordering, ultimately affecting the electrochemical performance. While increasing the embodied energy and decomposition temperature of the organic additive tended to increase particle size, which is beneficial for the performance of single-crystal NMC811 up to a point, there was a corresponding tradeoff between this particle growth and increases in structural disorder that reduce electrochemical performance. This tradeoff results in a balancing of factors being necessary to achieve optimal performance using this simplified procedure, or the adjustment or addition of further process steps to control one or both properties.

To evaluate one of these potential process changes, examples 27-33 used an additional heat treatment step intended to reduce structural disorder while maintaining particle size effects. Upon addition of this step, the first cycle electrochemical performance of the resulting samples 554-566 produced with different organics collapsed into one another, and the primary influence of the organics remained on the particle size of the NMC811 material. The general trend of increasing particle size with increases in enthalpy of combustion and decomposition temperature remained, although additional challenges were encountered due to the need to deagglomerate the sintered particles resulting from the use of the organic additive. With further process development this procedure remains a viable method for tuning the synthesis of NMC811 cathode material, and potentially simplifying the manufacturing process by allowing access to simplified calcination procedures.

Large Scale Production of LiNi_{0.8}Mn_{0.1}Co_{0.1}O₂ Using Method 500

The differences in physical properties and electrochemical performance in samples resulting from the solid-state production of NMC811 cathode active material at intermediate (300 g) scale with 600 and without an organic additive 602 were investigated. Powder x-ray diffraction (XRD) and scanning electron microscopy (SEM) were conducted on both experimental samples to assess the crystal structure, phase purity, and particle size and morphology. Particle size analysis was also performed using a laser diffraction particle size analyzer (Horiba LA960).

Electrochemical testing was performed using lithium anode coin half-cells with cathode electrodes from powders 600, 602 cast onto carbon-coated aluminum foil. Cathode electrodes were made utilizing a mixture of CAM, a conductive additive (carbon black), and a polymer binder solution (12 wt % PVdF in NMP solvent) in a mass ratio of 85:7:8 CAM: carbon black: PVdF, along with additional solvent. The loading of active material ranged from 4-6 mg/cm2. Cells were cycled from 2.7V to 4.3V at 30° C. with an 8 hour rest after assembly using the following protocol: 3 cycles at constant current charge and discharge rate of C/10 with a C/20 constant voltage hold at the top of charge and a 30 minute rest between cycles. Continued cycling at C/3-D/3 with a 30 minute rest between cycles.

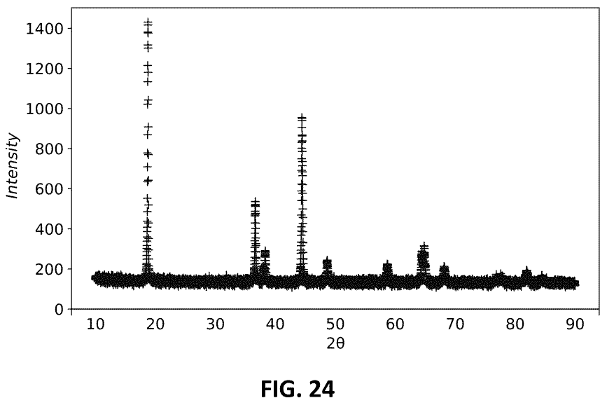

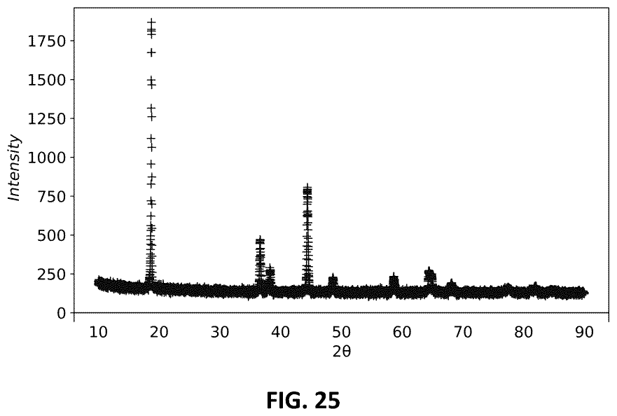

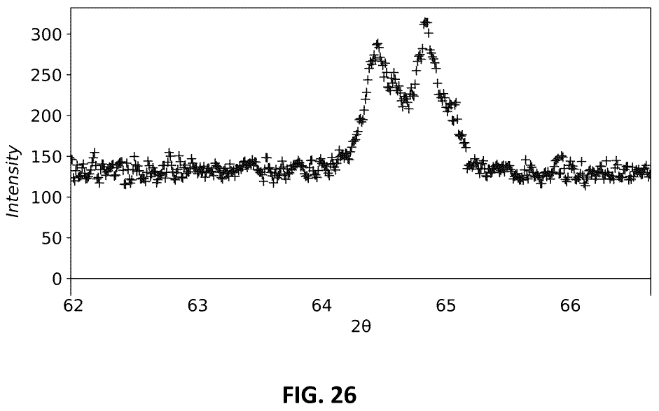

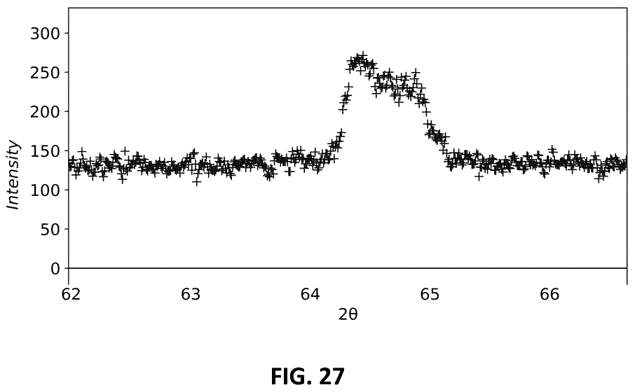

The first property analyzed for these materials was the crystal structure, for which the powder XRD patterns of both samples 600 and 602 are shown in FIGS. 24 and 25, respectively. Both samples show the expected diffraction pattern for the NMC811 layered structure and appear phase pure, indicating that both reactions were generally successful at producing the targeted phase. Upon closer inspection though, there did appear to be some improvement in structural ordering resulting from the use of the organic additive. This is most evident when looking at the peak splitting of the (108) and (110) peaks at approximately 65 degrees two-theta, for which the oxamide sample shows a more prominent splitting in the close-up images FIGS. 26-27, indicating better ordering of the layered structure. FIG. 26 is the close up of XRD pattern for NMC811 600 synthesized with oxamide between 64-65 degrees two-theta. FIG. 27 is the close up of XRD pattern for NMC811 602 synthesized without organic additive between 64-65 degrees two-theta.

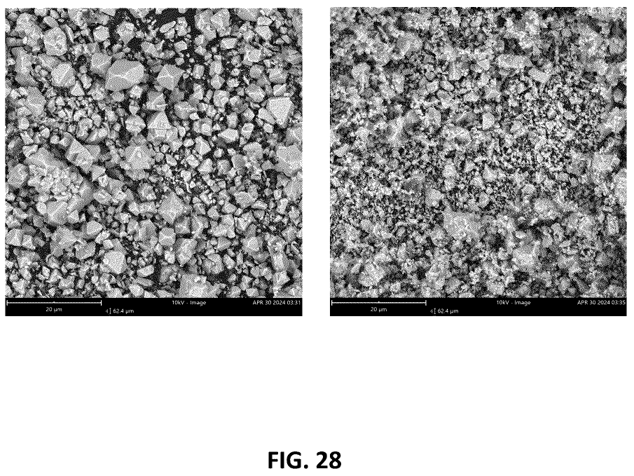

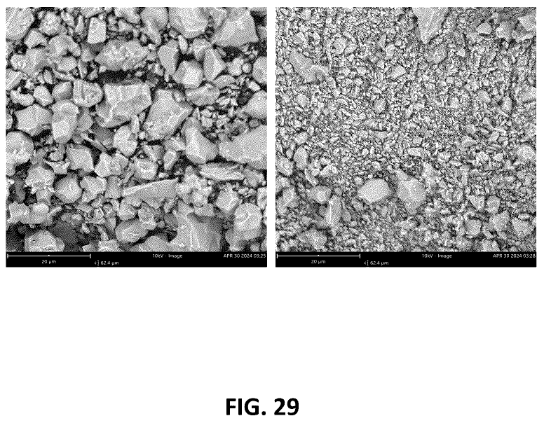

Despite the appearance of good structural ordering in the XRD images, titration of material from each sample to quantify the amount of lithium hydroxide and/or carbonate on the surface showed significant presence of residual lithium hydroxide (4-5 wt % for the experimental samples vs<0.5 wt % for baseline materials). This exceeds what would be expected from the lithium excess provided, and may indicate that there was incomplete lithiation of the bulk material, leaving some of the lithium hydroxide unreacted instead of inserting into the layered structure. This may be the result of bulk transport inhibitions in the larger batch size, but may potentially be ameliorated by using a rotating furnace or by careful control of bed height in a static furnace. Both samples 600, 602 showed the formation of single crystal structures after calcination with micron sized primary particles. However, the samples needed to be ground to break up aggregates before they may be cast for electrochemical testing, so to capture the effects of milling the material before electrochemical testing, SEM images were taken both before and after milling, and are shown in FIGS. 28-29.

FIG. 28 is SEM images of NMC811 600 synthesized with oxamide and FIG. 29 is SEM images of NMC811 602 synthesized without organic additive (20 μm scale bar). As synthesized material is on the left and after milling for electrochemical testing is the image on the right.

While the sample without the organic additive 602 shows generally larger particle size in the as synthesized image, the sample with the organic additive 600 appears to display more uniform morphology with a fairly consistent octahedral shape. This may be advantageous for promoting more diffusion of lithium into and out of the structure and creating more uniform redox behavior during cycling.

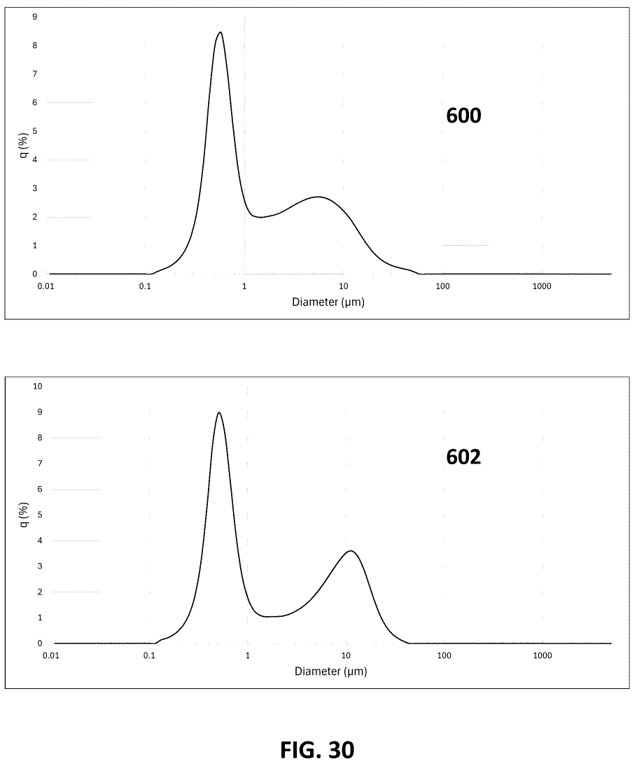

Both samples 600, 602 also showed an expected but significant decrease in particle size upon milling, as well as the formation of fine, submicron sized particles. This mix of submicron sized particles and micron sized particles shown in the images of milled samples is consistent with the particle size distribution of the material before electrochemical testing, which are shown in FIG. 30.

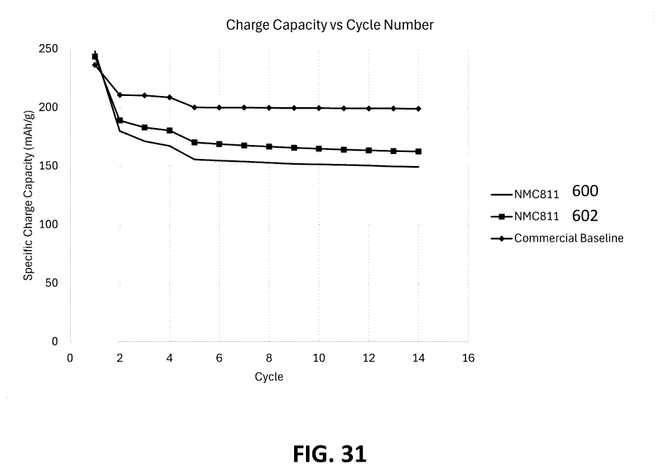

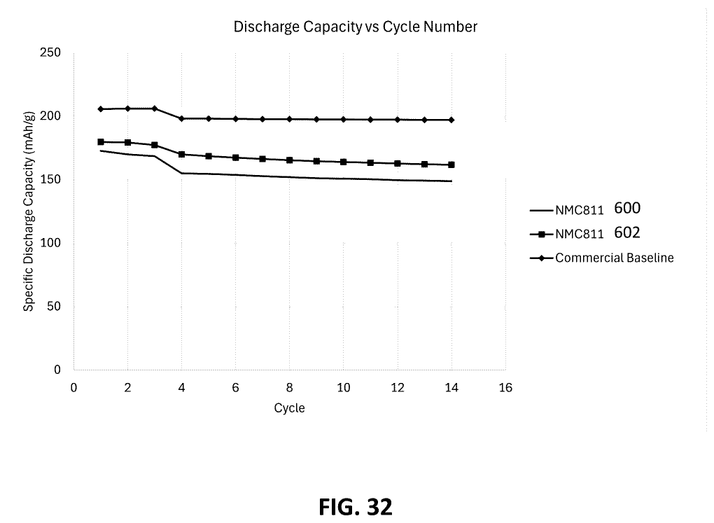

This larger number of fine particles presents a challenge to the electrochemical performance of the material, as it can be more difficult to create an electrode with sufficient electrical contact between these small, disparate particles to provide good capacity. While the two samples 600, 602 appear similar in many respects from a physical characterization standpoint, there are still moderate differences in their electrochemical performance, albeit with both of them falling below the performance of baseline materials. The charge capacity as a function of cycle number is shown in FIG. 31 where the top plot line is a commercial baseline sample, the middle plot line is sample 600 and the bottom plot line is sample 602. The discharge capacities as a function of cycle number are shown in FIG. 32 where the top plot line is a commercial baseline sample, the middle plot line is sample 600 and the bottom plot line is sample 602.

The following Table 3 displays the numerical values of certain key metrics:

TABLE 3

| | 1st Charge | 1st Discharge | |
|---|---|---|---|
| | Capacity (mAh/g ± | Capacity (mAh/g ± | First Cycle |
| Sample | Std Dev) | Std Dev) | Efficiency (%) |
| Sample 600 | 243.29 ± 25.93 | 179.53 ± 4.08 | 73.80% |
| Sample 602 | 247.77 ± 24.80 | 172.51 ± 1.35 | 69.60% |
| Commercial | 236.13 ± 2.91 | 205.50 ± 2.57 | 87.00% |
| Baseline | | | |

Both materials 600, 602 produced at this scale show low initial capacity for NMC811 material (170-180 mAh/g first discharge capacity vs ˜200 mAh/g for baseline materials), but show fairly normal cycling stability at C/3 discharge rates. While the first charge capacities favored the organic free sample 602 slightly, the sample synthesized with oxamide 600 showed better performance after the first charge, including better rate capability during C/3 cycling.

The use of organic additives as a means of allowing the production of NMC811 cathode material at larger scales continues to show promising results. The addition of the organic additive appears to yield improvements in both structural ordering and the formation of uniform single crystal particles at this larger scale, which despite not achieving the same performance as baseline materials still yield an improvement over the organic-free material with respect to electrochemical properties. While other aspects of process development are needed to fully commercialize this synthetic route, the addition of the organic additive remains a potential avenue for improving the viability of this approach.

### Lithium Metal Phosphates

The following embodiments relate to a method to manufacture a metal phosphate, in particular a lithium metal phosphate.

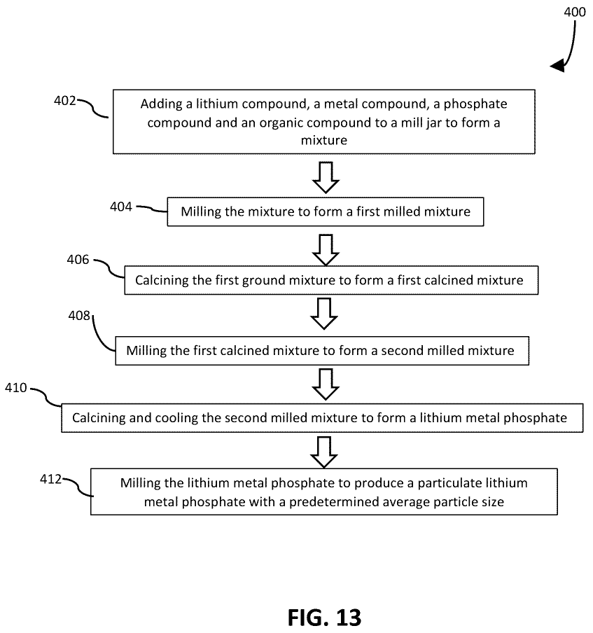

FIG. 13 is a block diagram of a melt-based method 400 to manufacture a particulate lithium metal phosphate, according to an embodiment of the disclosure. The method of manufacture of lithium metal phosphate is similar to that of method 100 disclosed herein for the synthesis of lithium metal oxides. An organic compound, a lithium-based compound, a transition metal-based compound and a phosphate containing compound is added to a mill jar 402. The phosphate containing compound may be selected from the group consisting of (NH₄)₃PO₄, H₃PO₄, Na₃PO₄, Li₃PO₄, K₃PO₄, H(NH₄)₂PO₄, and H₂(NH₄)PO₄. The mixture is milled to form a first milled mixture 404.

The first milled mixture is then calcined to form a first calcined mixture 406. The first calcined mixture is cooled and milled a second time to form a second milled mixture 408. The second milled mixture is calcined to form a lithium metal phosphate 410. The lithium metal phosphate is cooled to form a lithium metal phosphate with general formula Li(M5)PO₄, where M5 is of iron, nickel, manganese, or cobalt. The lithium metal phosphate may then be milled and sized to produce a particulate lithium metal phosphate having a predetermined average particle size 412 that is suitable for use in a lithium-ion battery cell.

In some embodiments, step 408 may be eliminated such that there is no intermediate cooling and grinding step such that the calcined mixture in step 406 is then calcined to a high temperature to form the lithium metal phosphate.

In step 402, two or more metal compounds may be added with different metals to form a lithium mixed metal phosphate with general formula Li(M5)ₐ(M6)_{b}PO₄ where a+b=1, Li(M5)ₐ(M6)_{b}(M7)_{c}PO₄ where a+b+c=1, or Li(M5)ₐ(M6)_{b}(M7)_{c}(M8)_{d}PO₄ where a+b+c+d=1, and where M5, M6, M7, and M8 are selected from the group consisting of iron, nickel, manganese, and cobalt. The lithium metal phosphate or lithium mixed metal phosphate may be doped, such as for example, a transition metal. The dopant may be selected from the group consisting of Al, Ti, Zr, Mg, B, F, W, Mo, V, Ta, Ga, Nb, Zn, Cs, and Ca.

The following are experimental syntheses of various cathode compositions using the methods disclosed herein.

### EXAMPLES

### Example 1-Synthesis of LiNi_{0.8}Mn_{0.1}Co_{0.1}O₂ using Citric Acid 300

Reagents were weighed out to +0.0002 g of the calculated mass. To a weigh boat combine add 0.50 moles of NIO, 0.0625 moles of MnO, and 0.0625 moles of CoO. LiOH was added in a molar ratio of 1.1:1 Li: transition metal ratio and citric acid was added in a molar ratio of 0.1:1 oxalic acid to transition metal to form a powder mixture. The powder mixture was added to a YSZ ball mill that was pre-loaded with 10 mm and 12 mm YSZ milling balls with a weighted average diameter of 11.37 mm and weighing a total of 300 g. The powder mixture was milled for 1 hour at 300 rpm. The ground powder mixture was placed in an alumina crucible in a muffle furnace and heated under a flow of oxygen at 2 L/min at a ramp rate of 2° C./min to 150° C. and held for 3 h, then heated to 250° C. at 2° C./min and held for 5 h, then heated to 350° C. at 2° C./min and held for 3 h, then heated to 550° C. at 2° C./min and held for 5 h. The powder was cooled to room temperature and ground again. The ground powder was further calcined under a flow of oxygen at 2 L/min at a ramp rate of 2° C./min to 930° C. and held for 14 h to form LiNi_{0.8}Mn_{0.1}Co_{0.1}O₂ 300. The LiNi_{0.8}Mn_{0.1}Co_{0.1}O₂ 300 was cooled to room temperature and ground again to yield a single crystalline black powder. FIG. 3A is an SEM of particles of LiNi_{0.8}Mn_{0.1}Co_{0.1}O₂ made according to this Example 1. FIG. 3B is the XRD pattern of LiNi_{0.8}Mn_{0.1}Co_{0.1}O₂ made according to this Example 1.

### Example 2-Synthesis of LiNi_{0.8}Mn_{0.1}Co_{0.1}O₂ Using Oxalic Acid 302

LiNi_{0.8}Mn_{0.1}Co_{0.1}O₂ 302 was synthesized using a similar procedure for LiNi_{0.8}Mn_{0.1}Co_{0.1}O₂ 300 but oxalic acid was used instead of citric acid. FIG. 4A is an SEM of particles of made in this Example 2. FIG. 4B is the XRD pattern of the material made according to this Example 2.

### Example 3-Synthesis of LiNi_{0.8}Mn_{0.1}Co_{0.1}O₂ Using Ascorbic Acid 304

LiNi_{0.8}Mn_{0.1}Co_{0.1}O₂ 304 was synthesized using a similar procedure for LiNi_{0.8}Mn_{0.1}Co_{0.1}O₂ 300 but ascorbic acid was used instead of citric acid. FIG. 5A is an SEM of particles of made in this Example 3. FIG. 5B is the XRD pattern of the material made according to this Example 3.

### Example 4-Synthesis of LiNi_{0.8}Mn_{0.1}Co_{0.1}O₂ Using Glucose 306

LiNi_{0.8}Mn_{0.1}Co_{0.1}O₂ 306 was synthesized using a similar procedure for LiNi_{0.8}Mn_{0.1}Co_{0.1}O₂ 300 but glucose was used instead of citric acid. FIG. 6A is an SEM of particles of made in this Example 4. FIG. 6B is the XRD pattern of the material made according to this Example 4.

### Example 5-Synthesis of LiNi_{0.8}Mn_{0.1}Co_{0.1}O₂ Using Glycine 308

LiNi_{0.8}Mn_{0.1}Co_{0.1}O₂ 308 was synthesized using a similar procedure for LiNi_{0.8}Mn_{0.1}Co_{0.1}O₂ 300 but glycine was used instead of citric acid. FIG. 7A is an SEM of particles of made in this Example 5. FIG. 7B is the XRD pattern of the material made according to this Example 5.

### Example 6-Synthesis of LiNi_{0.8}Mn_{0.1}Co_{0.1}O₂ Using Dimethyl Oxalate 310

LiNi_{0.8}Mn_{0.1}Co_{0.1}O₂ 310 was synthesized using a similar procedure for LiNi_{0.8}Mn_{0.1}Co_{0.1}O₂ 300 but dimethyl oxalate was used instead of citric acid. FIG. 8A is an SEM of particles of made in this Example 6. FIG. 8 is the XRD pattern of the material made according to this Example 6.

### Example 7-Synthesis of LiNi_{0.8}Mn_{0.1}Co_{0.1}O₂ Using Maltose 312

LiNi_{0.8}Mn_{0.1}Co_{0.1}O₂ 310 was synthesized using a similar procedure for LiNi_{0.8}Mn_{0.1}Co_{0.1}O₂ 300 but maltose was used instead of citric acid. FIG. 9A is an SEM of particles of made in this Example 7. FIG. 9B is the XRD pattern of the material made according to this Example 7.

### Example 8-Synthesis of LiNi_{0.8}Mn_{0.1}Co_{0.1}O₂ Using Phenanthrene 314

LiNi_{0.8}Mn_{0.1}Co_{0.1}O₂ 310 was synthesized using a similar procedure for LiNi_{0.8}Mn_{0.1}Co_{0.1}O₂ 300 but phenanthrene was used instead of citric acid. FIG. 10A is an SEM of particles of made in this Example 8. FIG. 10B is the XRD pattern of the material made according to this Example 8.

### Example 9-Synthesis of LiNi_{0.8}Mn_{0.1}Co_{0.1}O₂ Using Glucose 316 at 0.5:1 Molar Ratio of Glucose to Transition Metal

LiNi_{0.8}Mn_{0.1}Co_{0.1}O₂ 316 was synthesized using a similar procedure for LiNi_{0.8}Mn_{0.1}Co_{0.1}O₂ 306 but glucose was used at a higher 0.5:1 molar ratio of glucose to transition metal. FIG. 14 are XRD patterns of materials 306 and 316 made according to Examples 4 and 9 showing the effect of varying glucose content on crystallinity.

### Examples 10-26-Synthesis of LiNi_{0.8}Mn_{0.1}Co_{0.1}O₂ Using Modified Calcining Method 500 with Various Organic Additives

LiNi_{0.8}Mn_{0.1}Co_{0.1}O₂ 520-552 was synthesized using calcining method 500 but without the intermediate cooling step 506. Various organic additives were used at various concentrations as listed in Tables 1-2. Reactions were done using ˜0.103 moles of total transition metals in a molar ratio of 8:1:1 Ni: Mn: Co (0.082 moles NiO, 0.0103 moles MnO, 0.0103 moles CoO). Lithium hydroxide was added in a molar ratio of 1.1:1 Li to total transition metal. The organic additives were added in molar ratios ranging from 0.05:1 organic to total transition metal to 0.5:1 organic to total transition metal. Reagent materials were weighed to +0.0002 g inside an argon-filled glovebox and sealed inside YSZ milling jars for ball milling. The combined powders were milled for 1 hours at 300 rpm using 12 mm and 10 mm diameter YSZ milling balls in a ratio of 3:1 12 mm to 10 mm balls and 5:1 mass of balls to mass of powders. Ground powders were added to an alumina crucible and calcined in a controlled atmosphere muffle furnace with an oxygen flow of 2 L/min. The powders were heated from room temperature to 550° C. at 5° C./min and held for 5 hours, then heated from 550° C. to 700° C. at 5° C./min and held for 4 hours, then heated from 700° C. to 900° C. at 5° C./min and held for 8 hours, then cooled to room temperature. Powders were removed from the furnace and reground using a mortar and pestle to attain the final LiNi_{0.8}Mn_{0.1}Co_{0.1}O₂ powder.

### Examples 27-33-Synthesis of LiNi_{0.8}Mn_{0.1}Co_{0.1}O₂ Using Calcining Method 500 with Various Organic Additives

LiNi_{0.8}Mn_{0.1}Co_{0.1}O₂ 554-566 was synthesized using calcining method 500. Various organic additives were used at various concentrations as listed in Tables 1-2. Reactions were done using ˜0.110 moles of total transition metals in a molar ratio of 8:1:1 Ni: Mn: Co (0.0875 moles NiO, 0.0109 moles MnO, 0.0109 moles CoO). Lithium hydroxide was added in a molar ratio of 1.1:1 Li to total transition metal. The organic additives were added in molar ratios of either 0.05:1 organic to total transition metal or 0.1:1 organic to total transition metal, with one experiment in which no organic additive was used. Reagent materials were weighed to +0.0002 g inside an argon-filled glovebox and sealed inside YSZ milling jars for ball milling. The combined powders were milled for 1 hour at 300 rpm using 12 mm and 10 mm diameter YSZ milling balls in a ratio of 3:1 12 mm to 10 mm balls and 5:1 mass of balls to mass of powders. Ground powders were added to an alumina crucible and calcined in a tube furnace using the following procedure with an oxygen flow of 2 L/min. The powders were heated from room temperature to 125° C. at 5° C./min and held for 1 hour, then were heated from 125° C. to 550° C. at 5° C./min and held for 5 hours, then heated from 550° C. to 700° C. at 5C/min and held for 4 hours, then heated from 700° C. to 900° C. at 5° C./min and held for 5 hours, then cooled from 900° C. to 750° C. at 5° C./min and held for 6 hours, then cooled to room temperature.

### Synthesis of LiNi_{0.8}Mn_{0.1}Co_{0.1}O₂ Using Calcining Method 500 With 600 and Without 602 Organic Additive Oxamide

Reactions were done using ˜3 moles of total transition metals in a molar ratio of 8:1:1 Ni: Mn: Co (2.2-2.4 moles NiO, 0.27-0.30 moles MnO, 0.27-0.30 moles CoO). Lithium hydroxide was added in a molar ratio of 1.1:1 Li to transition metal. For the sample with the organic additive 600, oxamide was added in a molar ratio of 0.1:1 organic to transition metal. The total precursor mass for each sample was approximately 300 g. Reagent materials were dried in a vacuum oven overnight to remove adsorbed water, then weighed to +0.0002 g and combined. The combined powders were passed through a jet mill using a nitrogen gas feed source to form the precursor powder and were then collected. Ground powders were placed in an alumina tube furnace (i.e., using a straight alumina tube in the rotary kiln with no rotation, the material was kept in the constant temperature zone by two porous alumina plugs on either side) and calcined using the following procedure with an oxygen flow of 2 L/min: ramp from room temperature to 125° C. at 5C/min and dwell at 125° C. for 1 hr, ramp from 125° C. to 550° C. at 5C/min and dwell at 550° C. for 5 hr, ramp from 550° C. to 700° C. at 5C/min and dwell at 700° C. for 4 hr, ramp from 700° C. to 900° C. at 5C/min and dwell at 900° C. for Shr, cool from 900° C. to 750° C. at 5C/min and dwell at 750° C. for 6 hr, then cool to room temperature. Powders were removed from the furnace and reground using a mortar and pestle to attain the final NMC811 powders 600, 602 for electrochemical testing.

The invention has been described with reference to various specific and preferred embodiments and techniques. Nevertheless, it is understood that many variations and modifications may be made while remaining within the spirit and scope of the invention.

What is claimed is:

1. A method of producing a particulate lithium mixed metal oxide cathode material comprising the steps of:
providing an organic compound, having a melting point above 50° C.;
providing a lithium compound;
providing two or more metal compounds;
mixing the organic compound, the lithium compound, and the two or more metal compounds to form a mixture;
calcining the mixture at a calcining temperature, in an atmosphere containing oxygen to combust the organic compound and to form a lithium mixed metal oxide;
cooling the lithium mixed metal oxide to below 60° C.; and
sizing the cooled lithium mixed metal oxide to produce particulate lithium mixed metal oxide having a predetermined average particle size.

2. The method of claim 1, wherein the mixture is milled before calcining.

3. The method of claim 1, wherein the calcining step is achieved by a gradual addition of heat, so as to first melt the organic compound and then calcine the mixture, including the organic compound.

4. The method of claim 1, further comprising an intermediate calcining step after forming the mixture where the temperature is held for a period of time above the melting temperature but below the boiling point of the organic compound before calcining at higher temperatures to combust the organic compound.

5. The method of claim 1, further comprising an annealing step between the calcining step and the cooling step, in which annealing step the mixed metal oxide is held at an annealing temperature for at least 0.25 hours up to 10 hours and at a temperature in the range of 600-800° C.

6. The method of claim 1, further comprising an intermediate calcining step in an oxygen atmosphere after cooling the formed lithium mixed metal oxide.

7. The method of claim 5, further comprising an intermediate milling step after the intermediate calcining step.

8. The method of claim 7, further comprising a sizing step after milling.

9. The method of claim 1, wherein the cooled lithium mixed metal oxide is milled before sizing the cooled lithium mixed metal oxide.

10. The method of claim 1, wherein the organic compound is selected from the group consisting of citric acid, oxalic acid, ascorbic acid, glucose, glycine, dimethyl oxalate, phenanthrene, oxamide, maleic acid, tartaric acid, suberic acid, stearic acid, sucrose, linoleic acid and maltose.

11. The method of claim 1, wherein the organic compound is a polymer, an oligomer, or an aromatic compound or a non-aromatic compound and may comprise one or more functional groups selected from the group consisting of an amino, carboxylic acid, ether, amide, carbonate, acetate, and hydroxyl group.

12. The method of claim 1, wherein the organic compound is a monoacid, diacid, or triacid.

13. The method of claim 1, wherein the mixed metal oxide comprises a composition of LiNi_{0.8}Mn_{0.1}Co_{0.1}O₂.

14. The method of claim 1, wherein the two or more metal compounds comprises metals selected from the group consisting of manganese, nickel, aluminum, or cobalt.

15. The method of claim 1, wherein when the organic compound has a high heat of decomposition and low decomposition temperature or low heat of decomposition and high decomposition temperature results in larger particle sizes of the lithium mixed metal oxides than when the organic compounds have higher heat of decomposition and higher decomposition temperature or lower heat of decomposition and lower decomposition temperature.

16. The method of claim 1, wherein the lithium compound or the two or more metal compounds comprises an anionic component that is selected from the group consisting of hydroxide, carbonate, acetate, alkoxide, oxalate, nitrate, nitride, sulfate, and oxide.

17. The method of claim 1, wherein the lithium mixed metal oxide cathode further comprises an outer layer.

18. The method of claim 17, wherein the outer layer comprises Li and Co-rich material.

19. The method of claim 18, wherein forming the outer layer of Li and Co-rich material on the comminuted mixed metal oxide cathode comprises the following steps:
tumbling the lithium mixed metal oxide with Li and Co-containing precursor materials to form a coated lithium mixed metal oxide; and
calcining the coated lithium mixed metal oxide to form a lithium mixed metal oxide with a Li and Co-rich layer such that the Co does not substantially enter the structure of the lithium mixed metal oxide portion.

20. The method of claim 1, wherein the calcining step comprises the following steps:
placing the mixture in a calciner;
heating the mixture to about 125-175° C. at a ramp rate of up to about 30° C./min and holding for about 0.5 to ten hours;
heating the mixture to about 200-300° C. at a ramp rate of up to about 15° C./min and holding for about 0.5 to ten hours;
heating the mixture to about 300-400° C. at a ramp rate of up to about 10° C./min and holding for about 0.5 to ten hours;
heating the mixture to about 500-600° C. at a ramp rate of up to about 10° C./min and holding for about 0.5 to about ten hours;
heating the mixture to about 700-800° C. at a ramp rate of up to about 10° C./min and holding for about 0.5 to about ten hours;
heating the mixture to about 900-1000° C. at a ramp rate of up to about 10° C./min and holding for about 0.5 to about ten hours;
cooling the mixture to about 700-800° C. at a ramp rate of up to about 10° C./min and holding for about 0.5 to about ten hours; and
cooling to room temperature.

21. The method of claim 1, wherein calcining the mixture comprises the following steps:
heating to about 900-1000° C. at a ramp rate of up to about 0.25 to about 30° C./min and holding for about 0.5 to 10 hours; and
cooling the mixture to about 700-800° C. at a rate of up to about 0.25 to about 30° C./min and holding for about 0.5 to 10 hours.

22. The method of claim 1, further comprising adding a dopant to the mixture.

23. The method of claim 1, wherein the lithium mixed metal oxide cathode comprises a coating of an electrically conductive carbon.

24. The method of claim 1, wherein the particles are substantially single crystalline or polycrystalline and have a particle size in the range of about 1-100 microns.

25. The method of claim 1, wherein the organic compound is provided in an amount between about 0.01 and 50 mole percent of the metal compounds.
